(19) United States
(12) Patent Application Publication
(10) Pub. No.: US 2015/0348179 A1
(43) Pub. Date: Dec. 3, 2015

(54) VEHICLE RENTAL ADMINISTRATION SYSTEM, VEHICLE RENTAL ADMINISTRATION PROGRAM, VEHICLE RENTAL CUSTOMER TERMINAL, AND VEHICLE RENTAL CUSTOMER TERMINAL PROGRAM

(71) Applicant: Teruhiko Kamisawa, Yokohama-shi (JP)

(72) Inventor: Teruhiko Kamisawa, Yokohama-shi (JP)

(21) Appl. No.: 14/422,418

(22) PCT Filed: Aug. 22, 2013
(86) PCT No.: PCT/JP2013/072399

§ 371 Date: Feb. 19, 2015

(30) Foreign Application Priority Data
Aug. 22, 2012 (JP) PCT/JP2012/071231

(51) Int. Cl. G06Q 30/06; G06Q 10/02

(52) U.S. Cl. CPC G06Q 30/0645; G06Q 10/02

(57) ABSTRACT

A database includes usage condition data showing information about at which future time each of multiple parking sites prepared as rental sites and return sites for vehicles can be used for vehicle return. A control system specifies a reserved return site and a reserved return time relating to the new return reservation and sets a return reservation determining the specified reserved return site and reserved return time by ascertaining which parking site among multiple parking sites at which future time can be used, in response to a new return reservation request received from a first terminal among mobile terminals and/or vehicle-mounted terminals with reference to the usage condition data.

### CROSS-REFERENCE TO RELATED APPLICATION

This application claims priority to and the benefit of International Patent Application No. PCT/JP2012/071231, filed on Aug. 22, 2012, the disclosure of which is incorporated herein by reference in its entirety.

### TECHNICAL FIELD

The present invention relates to a technology of managing usage of vehicles according to a vehicle rental service.

### BACKGROUND ART

Conventionally, as one usage form of vehicles, an individual does not own a vehicle, but uses a vehicle rental service or a car sharing service that enables the individual to temporarily rent a vehicle only for a certain period of time (for several hours, a day, etc.) when it is necessary. These services provide various merits in that it is not necessary for an individual to maintain his/her own vehicle and load to the environment, such as air pollution, or traffic congestion caused by an increase in number of vehicles can be reduced.

However, according to a conventional vehicle rental system, when a rented vehicle is returned, the vehicle should be returned to an office where the vehicle was rented. Thus, it is complicated for a user to return a vehicle. For this reason, recently, a drop-off vehicle rental method with a drop-off option has become the mainstream (for example, Patent Literature 1, Non Patent Literature 1).

In the technology disclosed in Patent Literature 1, when information including a present location of a rental car is reported from the rental car via telephone sets, the usage stop of the rental car is recognized and the present location of the rental car is reported to a predetermined collecting mechanism to instruct collection of the rental car. Thus, a user is provided with a vehicle rental service by which when the usage of the rental car is ended, the rental car is left in an optional location at an optional time.

Further, as disclosed in Non Patent Literature 1, recently, a car sharing service with an available drop-off option has already been commercialized in all parts of Europe. In the car sharing service, upon finding a rental car, a registered member can ride in the car and immediately initiate usage of the car, and can also drop off the car in any location within a designated area. In other words, this is a vehicle rental service with available one-way usage or drop-off option.

The above-described service is based on the assumption that street parking is somewhat freely available. However, there are countries and areas where street parking is not allowed. Examples thereof include Japanese cities. In this case, from a realistic point of view, there may be developed a service in which a vehicle is rented and returned in a predetermined parking site using a private rental parking lot or a parking lot added to a commercial facility.

### CITATION LIST

### Patent Literature

[Patent Literature 1]
Japanese Patent Laid-Open No. 2002-358594

### Non Patent Literature

[Non Patent Literature 1]
Automotive Newspapers Inc. LIGARE December 2012, P18, Manufacturer-leading new monopoly, Why did Daimler launch car2go? Business and value added valid to “leaving cars”

### SUMMARY OF INVENTION

### Technical Problem

However, if a vehicle is rented and returned in a predetermined parking site, there is a concern about a decrease in convenience. When a vehicle is rented or a vehicle rental is reserved, if it is necessary to reserve a return with appointment for a parking site at a return site and a return time, the freedom of action in using a rented vehicle deteriorates.

In this regard, under the present conditions, in a vehicle rental service in which a vehicle is rented and returned in a predetermined parking site, there has not been established an effective technique to subsequently make a return reservation or a direct return separately from a vehicle rental or a reservation thereof.

An object of the present invention is to provide a technique that can improve convenience of a vehicle rental service in which a vehicle is rented and returned in a predetermined parking site.

### Solution to Problem

According to an aspect of the present invention, a vehicle rental management system that can communicate with multiple mobile terminals respectively carried by multiple customers and/or multiple vehicle-mounted terminals respectively provided on multiple vehicles and manages a vehicle rental business of renting the vehicles to the customers includes a control system that manages reservation and implementation of rental and return of the vehicles and a database accessed by the control system, wherein the database includes usage condition data showing information about at which future time each of multiple parking sites prepared as rental sites and return sites for the vehicles can be used for vehicle return, and the control system specifies a reserved return site and a reserved return time relating to the new return reservation request by ascertaining which parking site among the multiple parking sites at which future time can be used, in response to a new return reservation request received from a first terminal among the mobile terminals and/or the vehicle-mounted terminals with reference to the usage condition data, and sets a return reservation determining the specified reserved return site and reserved return time.

According to another aspect of the present invention, a vehicle rental management system that can communicate with multiple mobile terminals respectively carried by multiple customers, multiple vehicle-mounted terminals respectively provided on multiple vehicles, and/or site terminals respectively provided on multiple parking sites prepared as rental sites and return sites for the vehicles, and manages a vehicle rental business of renting the vehicles to the customers includes a control system that manages rental and return of the vehicles, and a database accessed by the control system, wherein the database includes usage condition data showing information about which vehicle is rented to which customer at which time and parking site data showing respective positions of the multiple parking sites and information about the site terminals, and the control system receives a notice of actual return from a second terminal among the mobile terminals, the vehicle-mounted terminals, and/or the site terminals, confirms a fact of implementation of the notified actual return based on the notice of actual return and the parking site data, specifies an actual return customer implementing the notified actual return based on the notice of actual return and the usage condition data, and specifies an actual return time at which the notified actual return is implemented based on the notice of actual return.

According to yet another aspect of the present invention, a vehicle rental management system that can communicate with multiple vehicle terminals respectively provided on multiple vehicles and manages a vehicle rental business of renting the vehicles to customers includes a control system that manages reservation and implementation of rental and return of the vehicles, and a database accessed by the control system, wherein the database includes parking site data showing information about multiple parking sites prepared as rental sites and return sites for the vehicles, and the control system ascertains a reserved return site and a reserved return time relating to a return reservation based on a parking site set as a destination and an estimated arrival time at the parking site determined based on a current position measured by the vehicle-mounted terminal, and sets a next rental reservation for the vehicle based on the return reservation.

According to still another aspect of the present invention, a vehicle rental customer terminal that can communicate a vehicle rental management server that manages a vehicle rental business of renting a vehicle to a customer, and is used by the customer includes a communication interface that transmits/receives a signal to/from the vehicle rental management server, and a control unit that communicates with the vehicle rental management server using the communication interface, wherein when the customer makes a return reservation for a vehicle being rented, the control unit transmits customer identification information of the customer or vehicle identification information of the vehicle and a desired return time or a desired return area input by the customer to the vehicle rental management server, receives parking sites or future times that can be used for return of the vehicle relating to the return reservation from the vehicle rental management server, suggests the received parking sites or future times to the customer so as to recommend the customer to select, and notifies the vehicle rental management server of the selected parking site or future time.

### Advantageous Effect of Invention

According to the present invention, it is possible to improve convenience of a vehicle rental service in which a vehicle is rented and returned in a predetermined parking site.

### BRIEF DESCRIPTION OF DRAWINGS

FIG. 1 is a conceptual diagram illustrating the overall configuration of a vehicle rental management system according to an embodiment.

FIG. 2 is a block diagram illustrating an internal configuration of a mobile terminal according to an embodiment.

FIG. 3 is a block diagram illustrating an internal configuration of a store terminal according to an embodiment.

FIG. 4 is a block diagram illustrating an internal configuration of a vehicle-mounted terminal according to an embodiment.

FIG. 5 is a block diagram illustrating an internal configuration of a vehicle rental management server according to an embodiment.

FIG. 6 is an explanatory diagram schematically illustrating a data structure of a database according to an embodiment.

FIG. 7 is a sequence diagram illustrating an operation at the time of setting a return site according to an embodiment.

FIG. 8 is a sequence diagram illustrating an operation at the time of setting a reservation according to an embodiment.

FIG. 9 is a flow chart illustrating an operation at the time of rental according to an embodiment.

FIG. 10 is a flow chart illustrating an operation at the time of return according to an embodiment.

FIG. 11 is an explanatory diagram illustrating a computer-readable storage medium that stores a vehicle rental management program according to an embodiment.

FIG. 12 is a sequence diagram illustrating an operation at the time of processing a rental reservation request according to an embodiment.

FIG. 13 is a flow chart illustrating an operation at the time of rental according to a modification example.

FIG. 14 is a flow chart illustrating an operation at the time of return according to a modification example.

FIG. 15 is a diagram illustrating a configuration of main components in a modification example of a database structure of a storage device 23.

FIG. 16A is a diagram illustrating a registration example of parking condition data 234B.

FIG. 16B is a diagram illustrating a registration example of parking condition data 234B.

FIG. 17A is a diagram illustrating a registration example of vehicle operation data 234C1.

FIG. 17B is a diagram illustrating a registration example of vehicle operation data 234C1.

FIG. 18 is a diagram illustrating a registration example of vehicle position data 234C2.

FIG. 19 is a diagram provided to explain a modification example of a usage condition database.

FIG. 20 is a diagram provided to explain another modification example of a usage condition database.

FIG. 21 is a flow chart illustrating a first example of the whole return reservation process.

FIG. 22 is a flow chart illustrating a second example of the whole return reservation process.

FIG. 23 is a flow chart illustrating a third example of the whole return reservation process.

FIG. 24 is a flow chart illustrating a fourth example of the whole return reservation process.

FIG. 25 is a diagram provided to explain a first example of the whole process for a direct return.

FIG. 26 is a diagram provided to explain a second example of the whole process for a direct return.

FIG. 27 is a diagram provided to explain a third example of the whole process for a direct return.

FIG. 28 is a diagram provided to explain a fourth example of the whole process for a direct return.

FIG. 29 is a diagram provided to explain a first example of a process for specifying a customer and a vehicle.

FIG. 30 is a diagram provided to explain a ninth example of a process for specifying a customer and a vehicle.

### DESCRIPTION OF EMBODIMENTS

Hereinafter, an embodiment of a vehicle rental management system according to the present invention will be described in detail with reference to the accompanying drawings. FIG. 1 is a conceptual diagram illustrating the overall configuration of a vehicle rental management system according to the present embodiment. Further, in the present embodiment, there will be explained a case where a vehicle C used by a customer U1 currently using the present system among customers of the present system is rented to another customer U2 after return of the vehicle C. Furthermore, in the present embodiment, a term “time” is assumed to include information about year, month, day, and hour.

As illustrated in FIG. 1, the vehicle rental management system manages usage of vehicles related to a vehicle rental service. The vehicle rental management system has a schematic configuration including a vehicle rental management server 2 that accumulates information about usage of a rented vehicle and provides usage information to be used for inspection through a communication network 3, a mobile terminal M1 and a mobile terminal M2 carried by a customer U1 and a customer U2 subsequently using the vehicle, respectively, and a store terminal M3 as an information processing terminal installed in a store S.

The vehicle rental management server 2 includes a group of multiple servers such as a database server that accumulates information about vehicle rental and a Web server that transmits the information about vehicle rental. A function of each server device is realized by a server computer that implements various information processes or software having such a function.

Herein, the Web server is a server computer that transmits information of HTML (Hypertext Markup Language) files, image files, music files and the like in a document system such as WWW (World Wide Web), or software having such a function, and serves to accumulate information such as HTML files or images about rental and transmit information about the rented vehicle in response to requests from the mobile terminals M1 and M2 and the store terminal M3 through the communication network 3.

The mobile terminals M1 and M2 are portable phones such as smart phones, cell phones, and mobile phones using wireless communication, and can receive a communication service such as call or data communication while being moved by way of wireless communication between a transfer point such as a base station and a mobile phone. A communication mode of this mobile phone may include, for example, a 3G communication mode, an FDMA mode, a TDMA mode, a CDMA mode, a W-CDMA mode as well as a PHS (Personal Handy phone System) mode or a public wireless LAN mode. Further, the mobile terminal M1 has a digital camera function, an application software execution function, or a GPS function and also serves as a portable information terminal.

The store S is, for example, an office of a vehicle rental company that manages the vehicle or a parking lot or a convenient store that makes a contract to use a parking site with the vehicle rental company, and each store secures a predetermined number of parking sites. Further, the store S may secure a parking site or may be a vacant lot. Also, the store terminal M3 is installed in the store S and connected to a reader 8.

The store terminal M3 is installed in the store S such as a convenient store and serves as an information processing terminal having a calculation processing function by a CPU and a communication processing function by a communication interface and can be realized by a general purpose computer such as a PC or a dedicated device (for example, a POS device, etc.) with a specialized function, and may include the same mobile computer as the mobile terminals M1 and M2, a PDA (Personal Digital Assistance), a mobile phone.

The reader 8 is a reader/writer device that reads customer identification information. The reader 8 is a contact type or non-contact type device. The contact type device may include an insertion type device by which a card having an IC chip or a magnetic card is inserted into a slot or a sliding type device by which such cards pass from top to bottom of a slit. The non-contact type device may include a device that has an antenna within a card having an IC chip and transmits and receives data using a weak wave generated from an external reader/writer device.

Further, in the present example embodiment, the reader 8 is configured to be externally connected to the store terminal M3, but the present invention is not limited to such a configuration. The reader 8 may be configured to read identification information of a customer and, for example, may be configured to be built in the store terminal M3.

The communication network 3 is a distributed IP network established by interconnecting various communication lines (optical lines such as FTTH, public lines such as ADSL, dedicated lines, wireless communication networks) using a communication protocol TCP/IP. The IP network includes Intranet (enterprise network) using 10BASE-T or 100BASE-TX or a LAN such as a home network.

A wireless base station 4 is connected to the communication network 3 through a repeater 5, and establishes wireless communication connection with respect to the mobile terminal M1 and provides call or data communication by the mobile terminal M1. The repeater 5 is a node device such as a modem, a terminal adapter, a gateway device, etc. for connection to the communication network 3, and selects a communication path or mutually converts data (signals) and performs a relay process between the wireless base station 4 and the communication network 3.

Further, the vehicle C is a car owned and managed by the vehicle rental company and includes various vehicles such as a van or a sedan or general vehicles such as a two-wheeled vehicle or a working vehicle, and the multiple vehicles C are assigned in each store. The vehicle C is equipped with a vehicle-mounted terminal 6. The vehicle-mounted terminal 6 is an electronic device that measures a current position of the vehicle and displacement thereof and electronically displays a current position or guidance to a destination during driving of the vehicle. Also, within the vehicle C, a key box for storing a key of the vehicle is installed. Further, herein, the vehicle C has been explained as an example, but the present invention can be applied to not only a car but also all kinds of vehicles or transportation means such as a ship as well as a two-wheeled vehicle or a bicycle.

(Functional Module of Each Device)

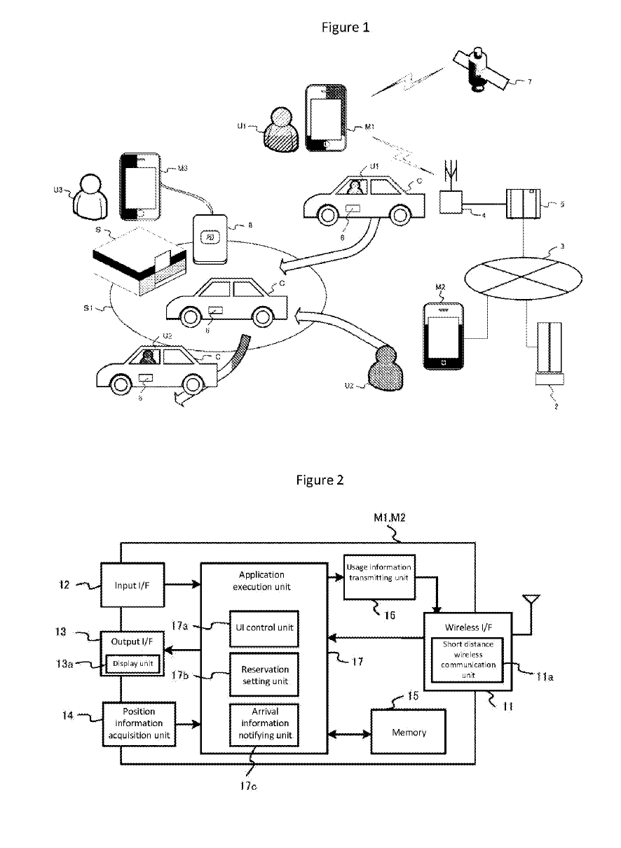

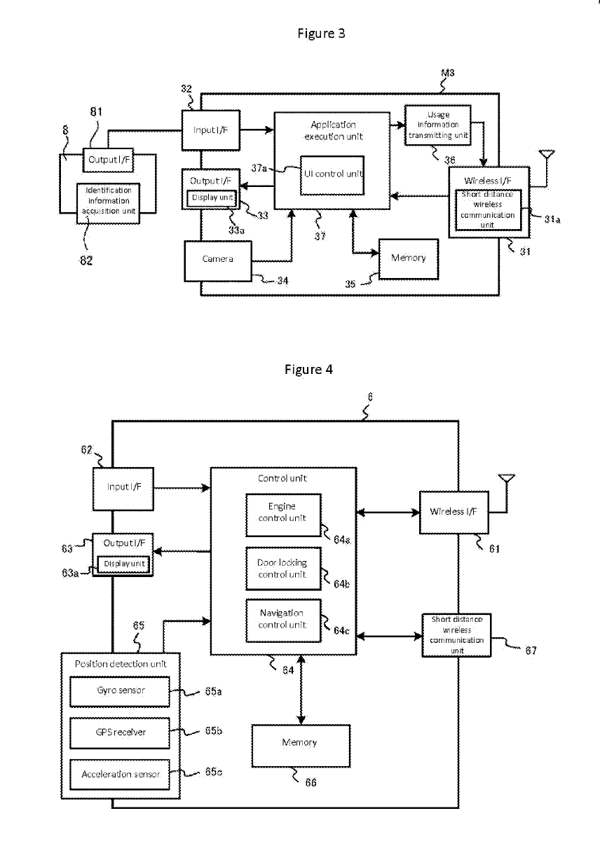

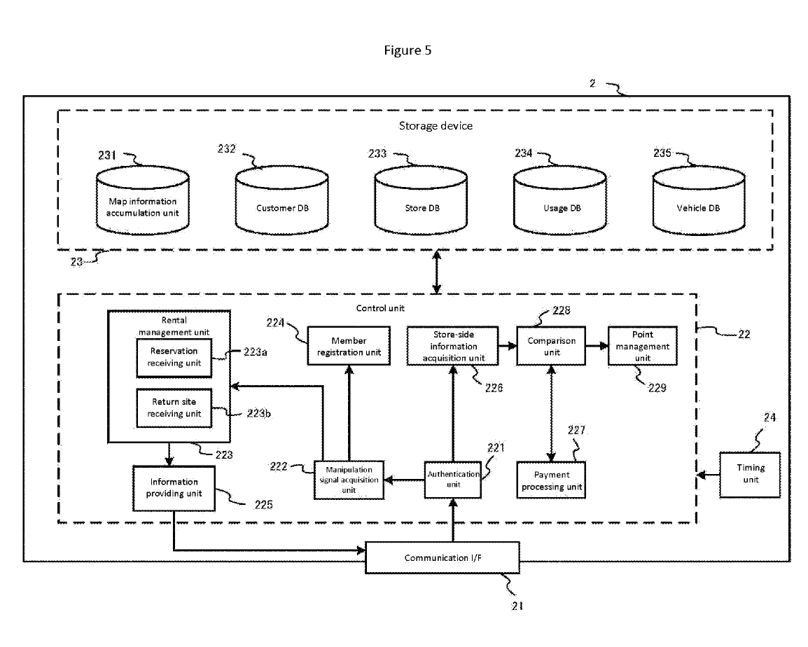

Then, an internal configuration of each device will be described in detail. FIG. 2 is a block diagram illustrating an internal configuration of each of the mobile terminals M1 and M2 according to the present embodiment, and FIG. 3 is a block diagram illustrating an internal configuration of a vehicle-mounted terminal according to the present embodiment. Further, FIG. 4 is a block diagram illustrating an internal configuration of a vehicle rental management server 2 according to an embodiment, and FIG. 5 is an explanatory diagram schematically illustrating a data structure of a database according to an embodiment. The term “module” used in the description refers to a functional unit comprised of hardware such as a device or a tool, software having such a function, or a combination thereof to achieve a predetermined operation.

(1) Mobile Terminals M1 and M2

Each of the mobile terminals M1 and M2 includes, as shown in FIG. 2, an input interface 12 and an output interface 13 as modules of a user interface system. The input interface 12 is a device, such as a manipulation button, a touch panel, or a jog dial, for inputting manipulation of a user. The output interface 13 is a device, such as a display or a speaker, for outputting image or sound. In particular, the output interface 13 includes a display unit 13a such as a liquid crystal display or the like.

Further, each of the mobile terminals M1 and M2 includes a wireless interface 11 as a module of a communication system. The wireless interface 11 is a wireless communication interface that enables call or data communication and is capable of transmitting and receiving packet data by way of wireless data communication. Further, the wireless interface 11 includes a short distance wireless communication unit 11a as a device for performing short distance wireless communication by way of Bluetooth (registered trademark) or UWB (Ultra Wide Band), and infrared radiation. Each of the mobile terminals M1 and M2 of the present embodiment is configured to transmit a customer ID as a unique identifier of each of the mobile terminals M1 and M2 to the store terminal M3 and the vehicle-mounted terminal 6 using the short distance wireless communication unit 11a.

The customer ID is the information for identifying a customer of the present system. In the present embodiment, if the mobile terminal includes a non-contact type IC chip (for example, FeliCa (registered trademark)) therein, a serial number stored in the IC chip is a customer ID. Also, if the mobile terminal does not include a non-contact type IC chip therein, for example, a telephone number may be a customer ID, or a membership card with a non-contact type IC chip may be issued separately so as to be carried by a customer.

Further, each of the mobile terminals M1 and M2 includes a position information acquisition unit 14 and a memory 15. The position information acquisition unit 14 is a module for measuring the current position of the device itself, and calculates the coordinates of the current position based on, for example, a GPS signal from a satellite 7 or enables each of the mobile terminals M1 and M2 to acquire its own position information in a propagation state of a base station identifier of a base station as a communication partner or signal intensity from this base station.

The memory 15 is a storage device for accumulating various data, and the memory 15 includes a control program for controlling various components or various initial setting values, font data, a vehicle rental management program according to the present embodiment, and a customer ID of each of the mobile terminals M1 and M2.

Further, each of the mobile terminals M1 and M2 includes an application execution unit 17 and a usage information transmitting unit 16 as modules of an application execution system. The application execution unit 17 is a module that executes various applications such as a general OS, browser software, a rental management application, etc., and is typically realized by a CPU or the like. When the application execution unit 17 as a control unit of each of the mobile terminals M1 and M2 executes an application for a rented vehicle, each of the mobile terminals M1 and M2 is operated as a mobile terminal for a customer of the rented vehicle.

The application execution unit 17 includes a UI control unit 17a, a reservation setting unit 17b, and an arrival information notifying unit 17c. The UI control unit 17a is established by executing a vehicle rental management application and is a module for reading a web page. The UI control unit 17a accesses the vehicle rental management server 2 to download HTML (Hypertext Markup Language) files or image files from the Internet, and analyzes layouts thereof and displays and reproduces them. In particular, in the present embodiment, the UI control unit 17a displays a vehicle rental reservation screen or a screen for setting a return site as information about a rented vehicle on the display unit 13a as a web page so as to be used for inspection.

To be specific, when the UI control unit 17a acquires a manipulation signal to start a reservation, position information acquired by the position information acquisition unit 14 or a GPS receiver 65b of the vehicle-mounted terminal 6 is acquired and a store S near the current position of the customer displays information of a vehicle being currently in a standby state and information of a vehicle which is preset to be returned to the store S on a reservation screen. Herein, the UI control unit 17a acquires information of a store where the vehicle C is stored and information of a vehicle model as information of the vehicle on standby through the vehicle rental management server 2 and acquires and displays information of an estimated arrival time of the vehicle C being currently used and information of a preset return site as arrival information. Further, when a setting screen of a return site is displayed, the UI control unit 17a acquires usage information of each store and displays whether or not there is a vacant space.

The reservation setting unit 17b is a module for setting a vehicle rental reservation according to manipulation of a user and configured to set a vehicle rental reservation based on information of a vehicle on standby and arrival information of a vehicle being returned, which are acquired from the vehicle rental management server 2. To be specific, when a vehicle that can be rented and a usage time from the reservation screen displayed on the display unit 13a, the selected information is transmitted as reservation information to the vehicle rental management server 2, and a reservation is set.

Further, before acquiring the arrival information, the reservation setting unit 17b receives in advance, as a rental reservation request process, a reservation request for rental of the vehicle C at a desired site designated based on manipulation of the next customer U2. The rental reservation request process is executed, for example, when there is no vehicle (including a vehicle scheduled to be returned) that can be rented in a store or area selected by manipulation of the next customer U2 or when a reservation time is ahead of the current time. In the present embodiment, when a preset store or a preset area including multiple stores is selected from the reservation screen displayed on the display unit 13a, and a usage time is inputted, the selected information is set as rental reservation request information and transmitted to the vehicle rental management server 2.

The arrival information notifying unit 17c is a module for setting a destination of a vehicle as a return site based on manipulation of a customer. In this case, the arrival information notifying unit 17c also has a function of calculating an estimated arrival time at the return site based on a measurement result (position information) obtained by the position information acquisition unit 14 or the GPS receiver 65b of the vehicle-mounted terminal 6, and notifying the vehicle rental management server 2 of the calculated estimated arrival time and set information about the return site as arrival information. To be specific, the arrival information notifying unit 17c calculates a driving distance based on information of the current position and information of the destination, and also calculates an estimated arrival time based on a speed limit on a road. Further, in this case, the arrival information notifying unit 17c can change the estimated arrival time by acquiring information of a traffic condition on the road.

Also, when setting a return site, the arrival information notifying unit 17c has a function of receiving a search condition and condensing destinations. This search condition can be set in various ways, and for example, enables search in a preset area, search by a kind of a store such as an office of the vehicle rental company or a convenient store, or search among stores only in the same field.

Further, in the present embodiment, when the customer U1 sets a destination, the arrival information notifying unit 17c has a function of displaying, as a candidate site, a desired site designated by a rental reservation request from the customer U2 such that the desired site can be selected, by referring to map information. Information of the rental reservation request is set to be frequently received from the vehicle rental management server 2 when a destination is set.

Further, the application execution unit 17 has an e-mail function and is configured to receive a reservation completion confirmation mail from the vehicle rental management server 2. Furthermore, when the vehicle rental management program is installed at the present terminal, the application execution unit 17 displays an initial setting screen to receive input of personal information, such as a name, an address, a birth date, of a customer. Also, in addition to such personal information, the application execution unit 17 is configured to extract and transmit a telephone number of the corresponding terminal and a serial number of the IC chip from the memory 15 to the vehicle rental management server 2.

The usage information transmitting unit 16 is a module for transmitting a manipulation signal from the input interface 12 to the vehicle rental management server 2, and transmits, for example, a request for inspection of the reservation and return screens, reservation information, or arrival information according to manipulation of a user. In this case, the usage information transmitting unit 16 is configured to transmit information of the current position or a customer ID together with the manipulation signal to the vehicle rental management server 2.

(2) Store Terminal M3 and Reader 8

The reader 8 is a device connected by wire or wirelessly to the store terminal M3, and as shown in FIG. 3, includes an identification information acquisition unit 81 and an output interface 82. The identification information acquisition unit 81 is a module for reading and acquiring customer identification information from each of the mobile terminals M1 and M2, and may use a contact type or non-contact type device that reads information from an IC card or an information terminal device.

The output interface 82 is a module for outputting the identification information acquired by the identification information acquisition unit 81 to the store terminal M3. In the present embodiment, the reader 8 and the store terminal M3 may be connected to each other by way of connection through USB cables or wireless communication such as Bluetooth. Further, a memory card such as a micro SD having a reading function may be used as the reader 8 to be directly incorporated in the store terminal M3.

Meanwhile, the store terminal M3 includes, as shown in FIG. 3, an input interface 32, an output interface 33, a communication interface 31, a memory 35, and an application execution unit 37.

The input interface 32 is a device, such as a mouse or a keyboard, for inputting manipulation of a user. The output interface 33 is a device, such as a display or a speaker, for outputting image or sound. In particular, the output interface 33 includes a display unit 33a such as a liquid crystal display or the like.

The communication interface 31 is a communication interface that enables call or data communication and is capable of transmitting and receiving packet data via the communication network 3. Further, the communication interface 31 includes a short distance wireless communication unit 31a as a device for performing short distance wireless communication by way of Bluetooth (registered trademark) or UWB (Ultra Wide Band), and infrared radiation. The store terminal M3 of the present embodiment is configured to receive a customer ID from each of the mobile terminals M1 and M2 using the short distance wireless communication unit 31a

The memory 35 is a storage device for accumulating various data, and the memory 35 includes a control program for controlling various components or various initial setting values, font data, various dictionary data, a vehicle rental management program according to the present embodiment, and a store ID as a unique identifier of the store terminal M3.

A camera 34 is an imaging device for capturing a still image or a dynamic image, and comprised of non-illustrated lens and CCD as fixed imaging elements. When incident light showing a subject image is image-formed on a light receiving surface, image data is transmitted to the memory 35 through a camera signal processing circuit and an A/D converter.

The application execution unit 37 is a module that executes various applications such as a general OS, browser software, a rental management application, etc., and is typically realized by a CPU or the like. The application execution unit 37 also includes a UI control unit 37a. The UI control unit 37a is established by executing a vehicle rental management application and is a module for reading a web page. The UI control unit 17a accesses the vehicle rental management server 2 to download HTML (Hypertext Markup Language) files or image files from the Internet, and analyzes layouts thereof and displays and plays them. Further, the UI control unit 37a displays a web page relating to a rental procedure and a return procedure so as to be available for inspection.

Also, the UI control unit 37a displays, on the screen, a frame for capturing images of the vehicle C at a preset angle by executing the rental management program, and enables a clerk U3 to capture images of the vehicle C in the displayed frame. Furthermore, if the next customer U2 is a first-time customer, a license of the next customer U2 is imaged by the camera 34 of the store terminal M3 and its image data is transmitted to the vehicle rental management server 2.

A usage information transmitting unit 36 is a module for transmitting a manipulation signal from the input interface 12 to the vehicle rental management server 2. In the present embodiment, the usage information transmitting unit 36 transmits manipulation signals relating to a rental procedure and a return procedure, image data of a captured vehicle C, a read customer ID according to manipulation of a clerk. Further, in this case, the usage information transmitting unit 16 is configured to transmit a store ID together with various data to the vehicle rental management server 2.

(3) Vehicle-Mounted Terminal 6

Further, an internal configuration of the vehicle-mounted terminal 6 will be described. FIG. 4 is a block diagram illustrating an internal configuration of the vehicle-mounted terminal 6. As shown in FIG. 4, the vehicle-mounted terminal 6 includes a wireless interface 61, an input interface 62, an output interface 63, a control unit 64, a position detection unit 65, a memory 66, and a short distance wireless communication unit 67.

The wireless interface 61 is a wireless communication interface that enables data communication and is capable of transmitting and receiving packet data by way of wireless data communication. Further, the wireless interface 61 has a function of acquiring traffic information or road information, such a traffic congestion, traffic control, and a congestion situation of a parking lot, in real time by receiving VICS (registered trademark) signals transmitted from the FM multiplex broadcasting or transmitters on the road. The short distance wireless communication unit 67 is provided on a side camera or a front glass on the driver seat side and configured as a device for performing short distance wireless communication by way of Bluetooth (registered trademark) or UWB (Ultra Wide Band), and infrared radiation and configured to read a customer ID from the mobile terminals M1 and M2 close to the unit.

The input interface 62 is a device, such as a manipulation button, a touch panel, or a jog dial, for inputting manipulation of a user. The output interface 63 is a device, such as a display or a speaker, for outputting image or sound. In particular, the output interface 63 includes a display unit 63a such as a liquid crystal display or the like.

The position detection unit 65 is a group of modules for detecting a position, a driving direction, and a speed of a vehicle, and includes a gyro sensor 65a, a GPS receiver 65b, and an acceleration sensor 65c. The gyro sensor 65a includes a 2-axes or 3-axes gyro sensor for detecting a posture or movement of the vehicle C, and a detection signal from the gyro sensor is transmitted to the control unit 64. In this case, the control unit 64 calculates a movement direction and a movement amount of the vehicle C based on the detection signal of the gyro sensor 65a.

The acceleration sensor 65c detects acceleration at the time of operating the mobile phone of the present embodiment, and a detection signal of the acceleration sensor 65c is transmitted to the control unit 64. In this case, the control unit 64 calculates acceleration of the vehicle C during movement based on the detection signal of the acceleration sensor 65c.

The GPS receiver 65b is a device configured to receive a radio wave transmitted from a geodetic satellite to measure the current position. To be specific, the GPS receiver 65b obtains the latitude and the longitude of the current position of the terminal itself based on a radio wave received by a GPS antenna. Further, GPS data (data showing the latitude and the longitude) are transmitted to the control unit 64.

The memory 66 is a storage device for accumulating various data or programs, and the memory 66 stores a control program for controlling various components by the control unit 64 or various initial setting values, font data, various dictionary data, a navigation program for executing a navigation function, a vehicle rental management program according to the present embodiment, and a vehicle ID for identifying the vehicle C. Further, the memory 66 accumulates information (customer IDs, use time, etc.) about usage conditions of the current customer and a customer who makes a reservation received from the vehicle rental management server 2.

The control unit 64 is an operation module comprised of hardware such as a processor, e.g., a CPU or a DSP (Digital Signal Processor), a memory, and other electronic circuits, software, such as a program, having such a function, or combinations thereof, and virtually establishes various functional modules by appropriately reading and executing a program, and the established functional modules control operations of the respective components and perform various processes in response to manipulation of a user. In particular, in the present embodiment, the control unit 64 executes a general road guiding function according to the navigation program in the memory 15, and also executes a function of returning a rented vehicle according to the vehicle rental management program.

To be specific, the control unit 64 includes a navigation control unit 64c, a door locking control unit 64b, and an engine control unit 64a. The navigation control unit 64c is a module for executing a general road guiding function, for example, by displaying, on a map, current position information obtained from the position detection unit 65, information of a destination or a transit point manually input by a customer, and a distance (path, route) from a departure point or the current position to the destination using map information.

The door locking control unit 64b is a module for controlling locking or unlocking of doors of the vehicle C. In the present embodiment, the door locking control unit 64b acquires a customer ID from each of the mobile terminals M1 and M2 through the short distance wireless communication unit 67 and determines whether or not the customer ID is identical with an ID of a customer who makes a reservation. Further, the door locking control unit 64b determines whether or not the current time is within a reservation time. Furthermore, if there is coincidence in the customer ID and the time information, the door locking control unit 64b unlocks the doors, and if the customer ID is different from the ID of the customer who makes a reservation or if the current time is different from the reservation time, the door locking control unit 64b maintains the doors in a locked state.

The engine control unit 64a is a module for controlling an engine of a vehicle. In the present embodiment, the engine control unit 64a acquires a customer ID of the mobile terminal M1 or M2 obtained through the short distance wireless communication unit 67 and determines whether or not the customer ID is identical with an ID of a customer who makes a reservation so as to perform a drive control of an igniter of the engine, for example, preventing of a key inserted into a key hole from being rotated. Further, the engine control unit 64a determines whether or not the current time is within a reservation time. In this case, the engine control unit 64a is linked to the door locking control unit 64b and performs a control based on a customer ID acquired at the time of opening and closing of the doors. Furthermore, after the doors are unlocked, each of the mobile terminals M1 and M2 may be moved towards the short distance wireless communication unit 67 to read a customer ID.

In the present embodiment, locking and unlocking of the doors is controlled by receiving a customer ID through the short distance wireless communication unit 67. However, for example, when position information of the mobile terminal M1 or M2 is compared with position information of the vehicle C according to the GPS function, if the mobile terminal M1 or M2 is close to the vehicle C, door lock can be unlocked.

Further, in the present embodiment, the control unit 64 also has a function of collecting trajectory of a vehicle by acquiring position information at a predetermined time interval. Such information is transmitted to the vehicle rental management server 2 and recorded in the storage device or the like. Such information may be disclosed only at the request of a public organization, for example, when an accident or an incident occurs.

(4) Vehicle Rental Management Server 2

FIG. 5 is a block diagram illustrating an internal configuration of the vehicle rental management server 2. The vehicle rental management server 2 has a function as a storage server that provides a storage region and a function as a Web server that transmits or manages information of vehicle rental, and may be comprised of a single server or multiple servers. A server management application executed in these server devices establishes various functional modules. To be specific, as shown in FIG. 4, the vehicle rental management server 2 includes a communication interface 21, a control unit 22, and various storage devices 23 (231 to 235).

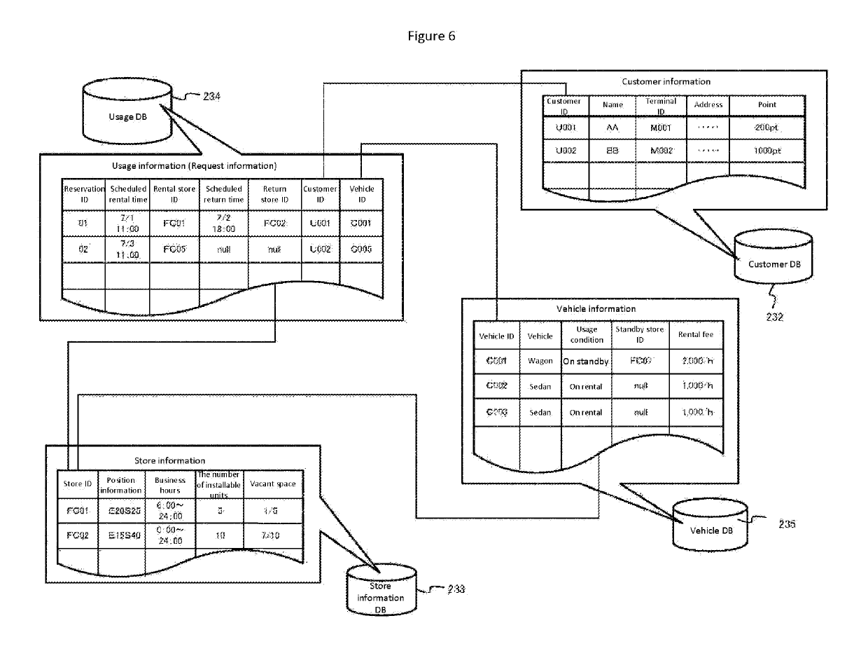

The storage devices 23 includes a map information accumulation unit 231 that accumulates map information, customer database 232 that accumulates information about customers, a store database 233 that accumulates information about stores, a usage condition database 234 that accumulates vehicle rental application information or usage condition, and a vehicle database 235 that accumulates information about vehicles C. As shown in FIG. 6, these units are relational databases forming an interrelation with multiple table data. The customer information, the store information, the usage information, and the vehicle information accumulated in the respective databases are interrelated with one another, and can be managed based on a vehicle ID, a customer ID and a store ID.

To be specific, the customer database 232 is table data relating to a customer using a vehicle rental management service. A customer ID for identifying the customer is assigned to the table data, and with this customer ID as an index, a mobile phone number, a name, an address of the customer, points given to the customer, or the like are recorded in the table data.

The store database 233 is table data that accumulates information about a store S that rents a vehicle C. A store ID for identifying the store S is assigned to the table data, and with this store ID as an index, position information, business hours, the number of installable units, and information of a current vacant space or the like are stored in the table data.

The vehicle database 235 is table data relating to information about the vehicle C and table data, for example, includes a vehicle ID, such as a vehicle registration number, for identifying the vehicle C, and information about the vehicle, usage condition, an ID of a store on standby, and a rental fee with this vehicle ID as an index.

The usage condition database 234 is table data relating to a usage condition including vehicle rental reservation information, and with a reservation ID, which is given at the time of receipt of a request for use, as an index, an estimated rental time, a store ID for identifying a rental store, an estimated return time, a store ID of a store to which a rented vehicle is returned, a store ID, and a vehicle ID are included in the table data.

The map information accumulation unit 231 is a storage device that accumulates map information about a preset area. In the present embodiment, a candidate site (a store, etc.) as a destination where a vehicle is rented and returned is accumulated as vector data on the latitude and longitude coordinates. Further, in such map information, an area, such as a prefecture, every municipality, the west exit and the east exit of a station, etc. where multiple stores are scattered is partitioned as a predetermined area, and adjacent areas have an overlapped portion, and in the overlapped portion, a single store or multiple stores are arranged. Furthermore, such map information is transmitted to the mobile terminals M1 and M2, and the vehicle-mounted terminal 6 and accumulated in each memory.

The communication interface 21 is an interface for transmitting and receiving data through the communication network 3 among the mobile terminals M1 and M2, the store terminal M3, or the vehicle-mounted vehicle 6. Through this communication interface 21, for example, data relating to a request for vehicle rental is transmitted and reservation information of the vehicle rental is received.

The control unit 22 is an operation module comprised of hardware such as a processor, e.g., a CPU or a DSP (Digital Signal Processor), a memory, and other electronic circuits, software, such as a program, having such a function, or combinations thereof, and virtually establishes various functional modules by appropriately reading and executing a program, and the established functional modules control operations of the respective components and perform various processes in response to manipulation of a user.

In the present embodiment, the control unit 22 is a group of modules for registration and request for vehicle rental, and includes an authentication unit 221, a manipulation signal acquisition unit 222, an information providing unit 225, a member registration unit 224, and a rental management unit 223.

The authentication unit 221 is a module for performing an authentication process using authentication information. To be specific, the authentication unit 221 is a computer for verifying legitimacy of an accessing person or software having such a function, and acquires a customer ID and a store ID through the communication network 3 and compares the IDs with the customer database 232 and the store database 233 to check whether or not the accessing person has a right to access and whether or not the accessing person is the person. Further, as an authentication method, for example, an ID and a password may be inputted on a web page and authentication may be performed based on the ID and password. Furthermore, an authentication process may be performed using a one-time password by transmitting a regularly changed password to the mobile terminals M1 and M2 and inputting a password during authentication.

The manipulation signal acquisition unit 222 is a module for acquiring manipulation of a user from each of the mobile terminals M1 and M2. In the present embodiment, if a manipulation signal is manipulation relating to member registration, the manipulation signal acquisition unit 222 transmits the information to the member registration unit 224, and if a manipulation signal is manipulation relating to rental or return of a vehicle, the manipulation signal acquisition unit 222 transmits the information to the rental management unit 223.

The information providing unit 225 is a module for transmitting various web data through the communication network 3. To be specific, the information providing unit 225 transmits web data for setting reservation or setting a return site to the mobile terminals M1 and M2 according to a control signal from the rental management unit 223. Further, the information providing unit 225 also has a function of transmitting web data for member registration relating to member registration of a customer to the mobile terminals M1 and M2 under the control of member registration unit 224.

The member registration unit 224 is a module for receiving member registration of the customer based on the input of the web data for member registration, and acquires a name, an address, a telephone number, and payment information of the customer. Further, the information received by the member registration unit 224 is accumulated in the customer database 232.

The rental management unit 223 is a module for managing rental or return of the vehicle C, and includes a reservation receiving unit 223a and a return receiving unit 223b in the present embodiment.

The return receiving unit 223b is a module for receiving arrival information relating to return of the vehicle C. In the present embodiment, when the return receiving unit 223b acquires a manipulation signal for setting a return site from the mobile terminal M1, based on position information acquired at the same time, the return receiving unit 223b selects a store having a vacant space in a predetermined area. Further, the return receiving unit 223b controls the information providing unit 225 to transmit a store ID of the store to the mobile terminal M1. In this case, if the return receiving unit 223b acquires rental reservation request information from the mobile terminal M2, the return receiving unit 223b also transmits information about a desired rental site.

Once the return receiving unit 223b acquires arrival information set by the customer from the mobile terminal M1, it records an ID of a store as a return site and an estimated arrival time included in the arrival information in the usage condition database 234. In this case, if the acquired arrival information is about a desired site designated in response to the rental reservation request, the return receiving unit 223b notifies the information to the reservation receiving unit 223a. Further, if there is a big difference between the current time and the estimated arrival time, the return receiving unit 223b may not record the information in the usage condition database 234, and if a difference between the current time and the estimated arrival time falls within a preset range, the return receiving unit 223b may reflect the information. In this case, it is possible to prevent a next customer from being unable to use due to a change of schedule.

Further, the return receiving unit 223b also has a function of requesting a customer U1 setting a destination as a return site to change the return site to a preset store. Such a function of requesting a return site is executed when a destination transmitted from the mobile terminal M1 is a store in an area adjacent to an area included in the rental reservation request information. To be specific, the return receiving unit 223b notifies the mobile terminal M1 of a message requesting a change of a return site to a store located in the overlapped adjacent areas. Thereafter, if the return receiving unit 223b acquires acceptance information of the change of a return site, the return receiving unit 223b confirms the change of a return site.

The reservation receiving unit 223a is a module for receiving a rental reservation for a vehicle C. In the present embodiment, when the reservation receiving unit 223a acquires a manipulation signal relating to a request from the mobile terminal M2, based on position information of the mobile terminal M2 acquired at the same time, the reservation receiving unit 223a selects, from the store database 233, a store close to a place where the customer is present, and selects a vehicle on standby in the store and a vehicle scheduled to be returned to the store.

With regard to selection of the vehicle C, based on the ID of the selected store, a vehicle including the ID of the selected store in a standby store column is selected with reference to the vehicle database 235 and a vehicle including the ID of the selected store in a return store column is selected with reference to the usage condition database 234. Further, the reservation receiving unit 223a controls the information providing unit 225 to transmit information about the vehicles available for rental (vehicles on standby and scheduled to be returned) and information about the store to the mobile terminal M2. Furthermore, together with the information about the vehicle scheduled to be returned, information about an estimated return time is also transmitted correspondingly.

Then, if the reservation receiving unit 223a acquires, from the mobile terminal M2, reservation information intending to rent a vehicle, the reservation receiving unit 223a adds a new reservation ID, and correlates the new reservation ID with a vehicle ID and usage time information included in the reservation information and records them in the usage condition database 234. Further, if the reservation receiving unit 223a acquires rental reservation request information from the mobile terminal M2, the reservation receiving unit 223a records, in the usage condition database 234, a store ID of a store corresponding to a desired rental site or store in a preset area and an estimated usage time.

Furthermore, the reservation receiving unit 223a also has a function of matching a desired site in a rental reservation request with a destination of a customer scheduled to return a vehicle. To be specific, when the reservation receiving unit 223a receives rental reservation request information from a next customer U2 and then, if a desired site as a return site is selected by the mobile terminal M1 of the customer U1, the reservation receiving unit 223a performs matching to rent the vehicle C to the customer U2 who requests reservation for the vehicle C under the condition that time or other conditions are matched. Also, if the rental reservation request information selects a desired area, the reservation receiving unit 223a determines whether or not the selected destination is in the desired area and performs matching.

Further, the reservation receiving unit 223a also has a function of requesting customer setting a reservation to rent a vehicle at a preset store. In this function of adding a rental site, for example, when a customer making a rental reservation desires rental of a vehicle C in a preset area but there is no vehicle in a corresponding store or area, a vehicle C scheduled to be returned to another store or area is searched for, and if it is found, a message requesting a change of a rental store is transmitted to a mobile terminal M2 of a customer U1.

Furthermore, the rental management unit 223 has an e-mail function and is configured to transmit a reservation completion confirmation mail to the mobile terminals M1 and M2 when the reservation receiving unit 223a and the return receiving unit 223b receive settings for reservation and return of the vehicle C.

The control unit 22 is a group of modules relating to a procedure in the store and management after the end of use and includes a store-side information acquisition unit 226, a comparison unit 228, a payment processing unit 227, a point management unit 229, and a timing unit 24.

The store-side information acquisition unit 226 is a module for acquiring a manipulation signal of a rental procedure and a manipulation signal of a return procedure transmitted from the store terminal M3 together with a customer ID and a store ID, and transmits such information to the comparison unit 228.

The timing unit 24 is a module for acquiring the current time. In the present embodiment, the timing unit 24 acquires, as a time to start a use or a time to end a use, a time when the manipulation signal of a rental procedure or the manipulation signal of a return procedure transmitted from the store terminal M3 is acquired, and transmits the time information to the comparison unit 228.

The comparison unit 228 is a module for comparing the information about a rental procedure or a return procedure acquired from the store terminal M3 with reservation information. To be specific, when the comparison unit 228 acquires the manipulation signal of a rental procedure, based on an ID of a customer acquired at the same time, the comparison unit 228 acquires reservation information corresponding to the customer ID from the usage condition database 234. Further, the comparison unit 228 compares the acquired store ID with a store ID included in the reservation information to determine whether or not these store IDs are identical with each other. Furthermore, the comparison unit 228 compares usage time information in the reservation information with the time information acquired by the timing unit 24 to determine whether or not the current time is within a reservation time.

Also, if the store IDs are identical with each other and the time is within the usage time information, information that a reserved vehicle can be rented is transmitted to the store terminal M3 in the form of web data or e-mail. Meanwhile, if there is no match in any one of the comparisons, information that the vehicle cannot be rented is transmitted to the store terminal M3 in the form of web data or e-mail. Further, the comparison unit 228 has a function of changing the content of the “usage condition” in the vehicle database during rental based on the vehicle ID if the rental is allowed.

Meanwhile, even when the manipulation signal of a return procedure is acquired, the comparison unit 228 acquires reservation information corresponding to the customer ID from the usage condition database 234 based on the acquired customer ID. Then, the comparison unit 228 compares the acquired store ID with the store ID included in the reservation information to determine whether or not the store IDs are identical with each other.

If the store IDs are not identical with each other, the store is different from a store to which the vehicle is scheduled to be returned. Therefore, information that the vehicle cannot be returned is transmitted to the store terminal M3 in the form of web data or e-mail. On the other hand, if the store IDs are identical with each other, information that the vehicle can be returned is transmitted to the store terminal M3 in the form of web data or e-mail. After allowing the return, the comparison unit 228 changes the content of the “usage condition” to “on standby” in the vehicle database. Further, in the present embodiment, if the store IDs are not identical with each other when the vehicle is returned, it is determined that the vehicle cannot be returned. However, for example, if a next reservation is not set, even when the store IDs are not identical with each other, it may be determined to allow return of the vehicle.

The comparison unit 228 also has a function of determining whether there is any scratch or contamination in the vehicle from the transmitted image data of the vehicle C during the return procedure of the vehicle C. To be specific, the comparison unit 228 stores the last image data of the vehicle and compares the data with the image data obtained this time from every imaging direction to determine whether there is new damage or contamination on a surface of the vehicle. Further, the determination on whether or not there is damage or contamination in the vehicle may be performed manually by an operator of the server or automatically by way of an image recognition process.

The point management unit 229 is a module for offering points functioning as incentives according to a usage condition of a customer with reference to the usage condition database 234, and offers points depending on a fee in the present embodiment. Further, the point management unit 229 offers additional points when a vehicle is returned to a scheduled return site or within a scheduled return time or even when a return site or a reservation site is changed in response to a request for a change from the return receiving unit 223b or the reservation receiving unit 223a. Furthermore, the point management unit 229 offers additional points when the customer U1 selects a desired rental site displayed as a candidate site when setting a destination.

The payment processing unit 227 is a module for performing a payment process based on the information accumulated in the usage condition database 234. To be specific, with reference to usage information accumulated in the usage condition database, the payment processing unit 227 performs a billing process to the customer U1 based on payment information in the customer database 232. In the billing process, for example, data intending to allow receipt of vehicle return is notified at the time when being transmitted to the store terminal M3, and, thus, a fee may be directly collected from the customer at the store or a payment process may be performed using a credit card registered in advance.

(Vehicle Rental Management Method)

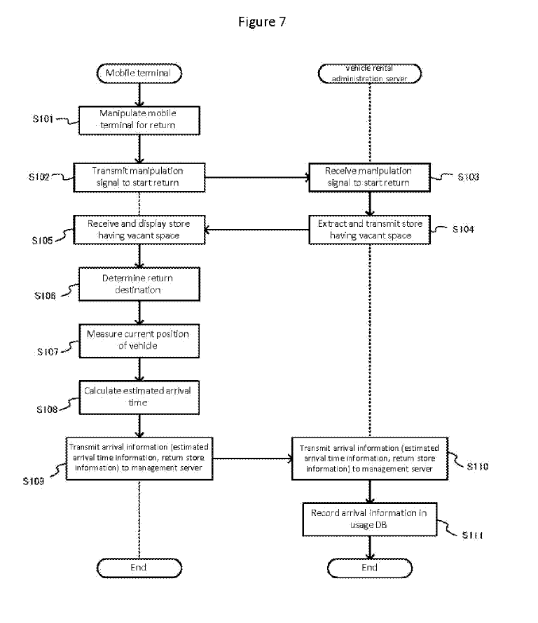

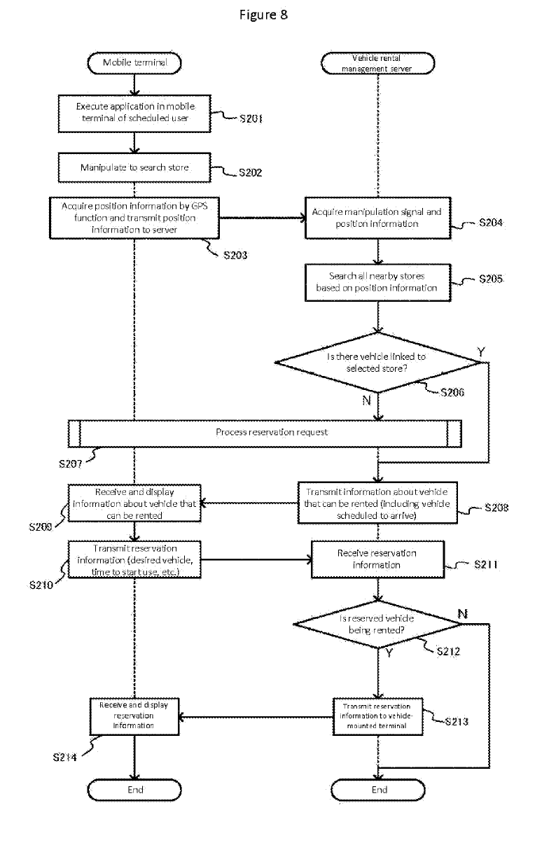

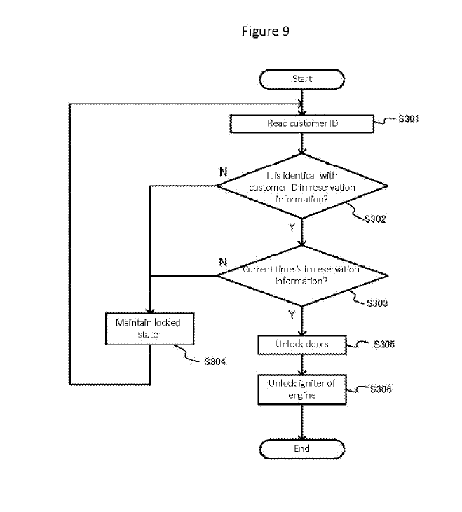

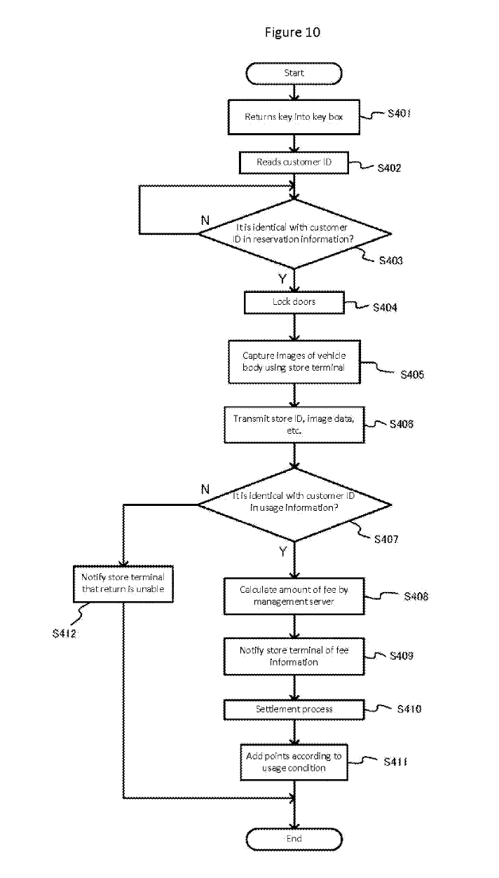

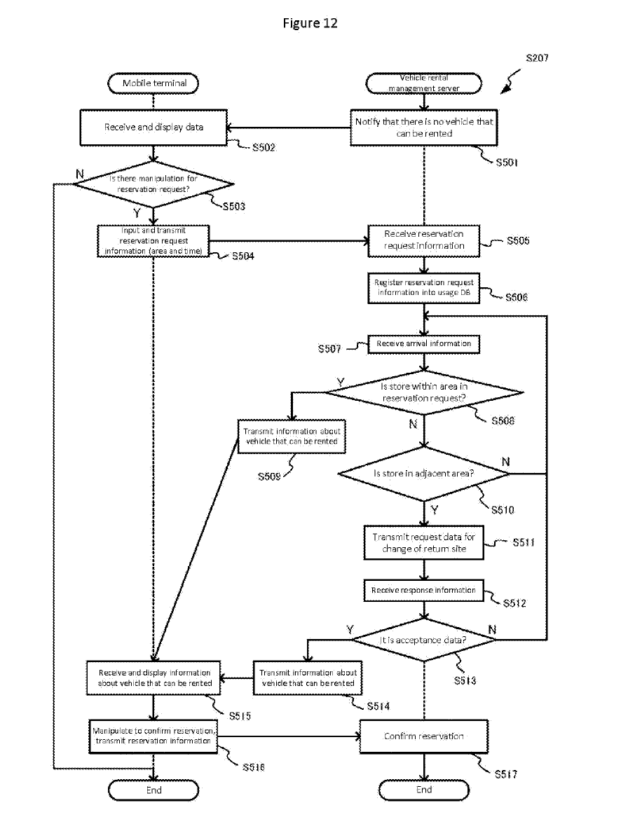

A vehicle rental management method of the present invention can be performed by operating the vehicle rental management system configured as described above. FIG. 7 is a sequence diagram illustrating an operation at the time of setting a return site according to the present embodiment, FIG. 8 is a sequence diagram illustrating an operation at the time of setting a reservation according to the present embodiment, and FIG. 12 is a sequence diagram illustrating an operation at the time of processing a rental reservation request according to the present embodiment. Further, FIG. 9 is a flow chart illustrating an operation at the time of rental according to the present embodiment, and FIG. 10 is a flow chart illustrating an operation at the time of return according to the present embodiment. Furthermore, herein, there will be explained, for example, a case where customers are registered in advance as members in the vehicle rental management server 2 and a vehicle C being currently used by a customer U1 is scheduled to be rented to a next customer U2.

(1) Operation for Setting Return Site

Firstly, an operation for making a reservation will be described. As illustrated in FIG. 7, if the customer U1 currently using the vehicle C manipulates the mobile terminal M1 by starting a vehicle rental management application and pressing a rental setting starting button for setting a return site (S101), the usage information transmitting unit 16 transmits a manipulation signal intending to start setting a return site together with a customer ID to the vehicle rental management server 2 (S102).

In the vehicle rental management server 2, when the manipulation signal intending to start setting a return site is acquired from the mobile terminal M1 (S103), the authentication unit 221 performs an authentication process with the customer ID or a vehicle ID. If authenticated, the return receiving unit 223b extracts latest information about a vacant space in each store, selects a store having a vacant space, and transmits a store ID to the vehicle-mounted terminal 6 (S104). Then, based on the store ID, the UI control unit 17a displays, on a screen, information about the store to which the vehicle can be returned (S105). Further, if information intending to request a rental reservation is received from the vehicle rental management server 2, based on map information, the arrival information notifying unit 17c displays, as a candidate site, a designated and desired site so as to be selected.

Then, if the store as a return site is selected by manipulation of the customer U1 (S106), the arrival information notifying unit 17c acquires position information from the GPS receiver 65b (S107), calculates an estimated arrival time at the return site (S108), and notifies the vehicle rental management server 2 of the estimated arrival time and the information about the return site store as arrival information (S109). The return receiving unit 223b acquires the arrival information (5110) and records a store ID of the return site and the estimated arrival time in the usage condition database 234 (S111).

(2) Operation for Making Rental Reservation

Hereinafter, an operation for making a rental reservation will be described. Firstly, as illustrated in FIG. 8, if the vehicle rental management application is started in the mobile terminal M2 of the next customer U2 (S201) to execute a manipulation signal relating to a request by pressing a store search button (S202), the position information acquisition unit 14 acquires information of the current position and the usage information transmitting unit 16 transmits the manipulation signal intending to search for a store and the position information to the vehicle rental management server 2 (S203).

If the reservation receiving unit 223a acquires the manipulation signal relating to a request from the mobile terminal M2 (S204), based on the position information of the mobile terminal M2 acquired at the same time, the reservation receiving unit 223a sets a predetermined area in a place where the customer is present and selects, from the store database 233, a store in the area close to the position of the mobile terminal M2 (S205).

If the reservation receiving unit 223a acquires the manipulation signal relating to a request from the mobile terminal M2 (S204), based on the position information of the mobile terminal M2 acquired at the same time, the reservation receiving unit 223a sets a predetermined area in a place where the customer is present and selects, from the store database 233, a store in the area close to the position of the mobile terminal M2 (S205). Further, herein, there has been described the case where the next customer U2 searches for a store close to the current position based on the GPS function. However, by manipulation of the customer U2, a predetermined area may be selected and a store in the area may be selected.

Then, based on a store ID of the selected store, the reservation receiving unit 223a determines whether or not there is a vehicle that can be rented (S206). To be specific, referring to the vehicle database 235, the reservation receiving unit 223a determines whether or not the store ID is present in a standby store ID column and verifies whether or not there is a vehicle on standby in the selected store. Further, referring to the usage condition database 234, the reservation receiving unit 223a determines whether or not the store ID is present in a return-scheduled store ID column and verifies whether or not there is a vehicle scheduled to be returned in the selected store.

Herein, if there is no standby vehicle and no return-scheduled vehicle in the selected store (“N” in S206), a rental reservation request process is performed (S207). On the other hand, if there is a standby vehicle and a return-scheduled vehicle in the selected store (“Y” in S206), the return receiving unit 223b controls the information providing unit 225 to transmit information about a vehicle that can be rented (including information about a vehicle scheduled to be returned) and information about the corresponding store to the mobile terminal M2 (S208). Further, the information about a vehicle scheduled to be returned is transmitted together with an estimated return time.

When the information about a vehicle that can be rented and the information about a store are acquired, the UI control unit 17a displays such information on the display unit 13a. Then, when the next customer U2 selects a certain vehicle C through the input interface 12 and inputs a usage time, thereby making a reservation for vehicle rental (S209), the reservation setting unit 17b transmits, as reservation information, an ID of the selected vehicle and the usage time to the vehicle rental management server 2 through the communication network 3 (S210).

The reservation receiving unit 223a acquires the reservation information and records the information in the usage condition database 234, thereby performing a reservation setting process (S211). In this case, based on a vehicle ID of the reserved vehicle C, the reservation receiving unit 223a determines whether or not the vehicle C is being currently rented, with reference to the usage condition database 234 (S212).

If the reserved vehicle C is not being rented (“N” of S212), the process is ended. On the other hand, if the reserved vehicle C is being rented (“Y” of S212), the reservation receiving unit 223a transmits reservation information indicating confirmation of a next reservation from the usage condition database 234 to the mobile terminal M1 of the customer U1 or the vehicle-mounted terminal 6 (S213). The UI control unit 17a of the mobile terminal M2 receives such reservation information and displays the information on the screen (S214).

(3) Operation for Processing Rental Reservation Request

Then, a process of the rental reservation request in step S207 will be described. FIG. 12 is a sequence diagram illustrating an operation for processing a rental reservation request. Further, in the present embodiment, for example, there will be described a case where it is desired to rent a vehicle from a store in a preset area as a rental reservation request.

Firstly, the reservation receiving unit 223a of the vehicle rental management server 2 notifies the mobile terminal M2 that there is no vehicle that can be rented near the area desired by the next customer U2 (S501).

When receiving such information, the UI control unit 17a displays the information together with an icon for starting a rental reservation request process on the screen at the same time (S502). Then, the reservation setting unit 17b determines whether or not the rental reservation request is processed (S503). Herein, if the rental reservation request process is not performed (“N” of S503), the process is ended. On the other hand, if the rental reservation request process is performed (“Y” of S503), a desired area for rental and information about an estimated usage time are inputted and transmitted to the vehicle rental management server 2 (S504).

The reservation receiving unit 223a acquires such rental reservation request information (S505) and registers, into the usage condition database 234, such information as a rental reservation request (S506). Then, the reservation receiving unit 223a waits until information about a return site of the customer U1 is acquired.

Then, when the return receiving unit 223b acquires information of a store as a return site from the mobile terminal M1 and arrival information including a an estimated arrival time (S507), based on a store ID, the return receiving unit 223b determines whether or not the store is a store in the preset area requested to be reserved for rental (S508). If the store is a store in the area set by the rental reservation request (“Y” of S508), information about the store and a time available for rental are transmitted to the mobile terminal M2 of the next customer U2 making the rental reservation request (S509).

The UI control unit 17a displays the information about the store as a return site of the vehicle and the time information on the screen (S515). Then, if the next customer U2 executes a manipulation intending to confirm rental in the store, the reservation setting unit 17b transmits such confirmation information to the vehicle rental management server 2 (S516). Thereafter, the reservation receiving unit 223a acquires such reservation information and renews the rental reservation request information to confirm the reservation (S517).

On the other hand, if the store selected as a return site is not a store in the area set by the rental reservation request (“N” of S508), it is determined whether or not the store is a store in an adjacent area (S510). If the store is not a store in an adjacent area (“N” of S510), the process from the step S507 to the step S510 is repeated until the time information of the rental reservation request passes. After the time information of the rental reservation request passes, the mobile terminal M2 is notified that there is no store available to rent, and the process is ended. On the other hand, if the store is a store in an adjacent area (“Y” of S510), a message requesting a change of a return site is transmitted to the mobile terminal M1 in use (S511).

The UI control unit 17a of the mobile terminal M1 displays information about the request for a change on the screen and receives manipulation of a user. Then, when the return receiving unit 223b of the vehicle rental management server 2 receives response information (S512), the return receiving unit 223b determines whether or not the response information is a signal indicating acceptance (S513). If the response information is not information indicating acceptance (“N” of S513), the process from the step S507 to the step S513 is repeated until the time information of the rental reservation request passes. After the time information of the rental reservation request passes, the mobile terminal M2 is notified that there is no store available to rent, and the process is ended.

On the other hand, if the response information is information indicating acceptance (“Y” of S513), the reservation receiving unit 223a transmits information about the store and a time available for rental to the mobile terminal M2 of the next customer U2 making the rental reservation request (S514).

The UI control unit 17a displays the information about the store as a return site of the vehicle and the time information on the screen (S515). Then, if the next customer U2 executes a manipulation intending to determine rental in the store, the reservation setting unit 17b transmits such information to confirm the reservation to the vehicle rental management server 2 (S516). Thereafter, the reservation receiving unit 223a acquires such confirmation information and renews the rental reservation request information to confirm the reservation (S517). Further, in this case, based on information about the changed return site of the mobile terminal M1, the return receiving unit 223b renews the arrival information.

Furthermore, herein, there has been described an example where the customer U1 requests starting of return setting from the mobile terminal M1 and the vehicle-mounted terminal 6 makes a return reservation, the embodiment of the present invention is not limited thereto and can be modified and changed in various ways. For example, a return reservation can be made by any one of the mobile terminal M1 and the vehicle-mounted terminal 6. Specific examples of a return reservation will be described later.

(4) Operation for Vehicle Rental

Then, an operation for vehicle rental will be described. Firstly, the vehicle-mounted terminal 6 acquires a customer ID of the next customer U2 and usage time information from the vehicle rental management server 2 and accumulates such information in the memory 66. Then, as illustrated in FIG. 9, if the next customer U2 comes to the store S and causes the mobile terminal M2 to come close to the short distance wireless communication unit 67 of the vehicle C, the short distance wireless communication unit 67 reads a customer ID from the mobile terminal M2 (S301) and the control unit 64 compares the customer ID with the customer ID accumulated in the memory 66 (S302). Herein, if the customer ID is not identical with the customer ID accumulated in the memory (“N” of S302), the doors are maintained in a locked state so as to be in a standby state (S304).

On the other hand, if the customer ID is identical with the customer ID accumulated in the memory (“Y” of S302), it is determined whether or not the current time is within a reservation time (S303). Herein, if the current time is not within a reservation time (“N” of S303), the doors are maintained in a locked state so as to be in a standby state (S304). On the other hand, if the current time is within a reservation time (“Y” of S303), the door locking control unit 64b unlocks the doors (S305) and the engine control unit 64a unlocks the ignition of the engine (S306). Thereafter, the next customer U2 takes a key out of a key box and starts to drive the vehicle.

(5) Operation for Vehicle Return

Then, an operation for vehicle return will be described. As illustrated in FIG. 10, if the customer U1 comes to the store to return the vehicle C, the customer U1 returns a key into a key box (S401), and if the customer U1 causes the mobile terminal M1 to come close to the short distance wireless communication unit 67 of the vehicle C, the short distance wireless communication unit 67 reads a customer ID from the mobile terminal M1 (S402). The control unit 64 compares the customer ID with the customer ID accumulated in the memory 66 (S403). Herein, if the customer ID is not identical with the customer ID accumulated in the memory (“N” of S403), the doors are not locked so as to be in a standby state.

On the other hand, if the customer ID is identical with the customer ID accumulated in the memory (“Y” of S403), the door locking control unit 64b locks the doors (S404). Then, a clerk of the return site reads a customer ID from the memory 15 of the mobile terminal M2 using the reader 8 and also captures images of the vehicle C with the camera 34 while the vehicle rental management application is activated (S405). In this case, the clerk captures multiple images of the vehicle from preset directions so as to correspond to the frame for the vehicle displayed on the display unit 13a.

Further, if the clerk presses, for example, a return procedure starting button displayed on the display unit 33a, a return procedure manipulation signal, the read customer ID, the store ID, and the multiple image data are transmitted to the vehicle rental management server 2 (S406).

If the comparison unit 228 of the vehicle rental management server 2 acquires the return procedure manipulation signal, based on the customer ID acquired at the same time, the comparison unit 228 determines whether or not the store ID included in the reservation information is identical with the acquired store ID, with reference to usage information corresponding to the customer ID from the usage condition database 234 (S407).

If the store IDs are not identical with each other (“N” of S407), the store terminal M3 is notified of information indicating that return is not performed in this store (S412). On the other hand, if the store IDs are identical with each other (“Y” of S407), the payment processing unit 227 calculates an amount of fees according to a usage time (S408) and transmits the fee information to the store terminal M3 (S409). In this case, with reference to the customer database 232, if the customer has points, the payment processing unit 227 may subtract the amount of fees according to the points. Further, the comparison unit 228 determines whether there is damage or contamination in the vehicle from the acquired image data by way of an image recognition process, and if there is damage to the vehicle, an amount of fees is added.

The store terminal M3 acquires such fee information and performs a settlement process (S410). In this case, the settlement information is transmitted to the vehicle rental management server 2, and the point management unit 229 calculates points according to a usage condition of this time and accumulates the points in the customer database (S411). In this case, for example, if a reservation site or a return site is changed by request of the vehicle rental management server 2 or if the customer U1 selects a desired rental site displayed as a candidate site when setting a destination, additional points are offered. If a vehicle is returned later than a scheduled return time, a process of reducing points is performed as a penalty.

(Operation Effect)

According to the present embodiment as described above, if a vehicle return site is set based on manipulation of a customer, an estimated arrival time at a destination is calculated and a next reservation for the vehicle can be set based on the destination and the estimated arrival time. Thus, it is possible to rent the vehicle to a next customer immediately after the vehicle arrives at the destination. Therefore, it is possible to improve efficiency of vehicle rental and also possible to improve convenience of the customer.

Further, according to the present embodiment, the reservation setting unit 17b can receive in advance, as a rental reservation request process, a rental reservation request for the vehicle at a desired site designated by manipulation of a next customer before arrival information is acquired. Therefore, it is possible to increase a time period for request for a vehicle being currently used, thereby further improving usage efficiency of the vehicle.

Furthermore, according to the present embodiment, the arrival information notifying unit 17c displays a desired site of the rental reservation request as a candidate site so as to be selected with reference to map information when the customer U1 sets a destination. Therefore, it is possible to recommend the customer U1 to set the desired site as a return site, thereby further improving usage efficiency of the vehicle.

Moreover, according to the present embodiment, when the customer U1 sets a destination, if the customer U1 selects the desired site of the rental reservation request as the destination, the point management unit 229 offers additional points. Therefore, it is possible to call attention of the customer U1 to incentives when a desired site is set as a return site, thereby further improving usage efficiency of the vehicle.

Also, according to the present embodiment, based on a customer ID acquired by the short distance wireless communication unit 67 of the vehicle-mounted terminal 6, the doors of the vehicle are locked or unlocked and the engine of the vehicle is subject to drive control. Therefore, it is possible for only a customer making a reservation to drive the vehicle, and it is possible to prevent the vehicle from being used by other people.

(Vehicle Rental Management Program)

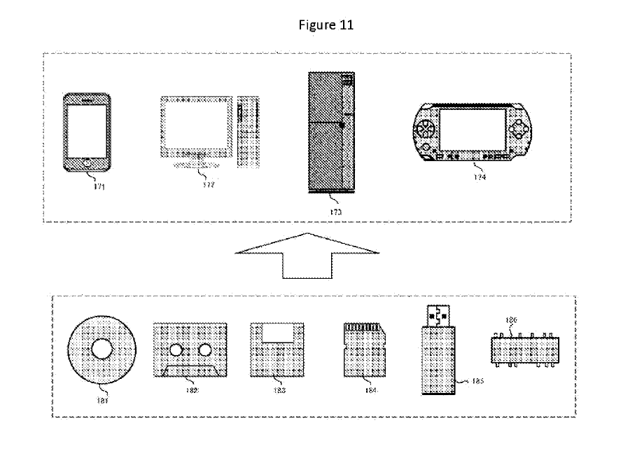

The above-described vehicle rental management system and vehicle rental management method according to the present embodiment can be realized by executing a vehicle rental management program described in a predetermined language in computers 171 to 174. That is, as illustrated in FIG. 11, by installing this program in a mobile phone as a personal digital (PDA), a mobile terminal 171 combining a communication function, a personal computer 172 used by a client side, a server device 173 arranged in a network and configured to provide data or a function to a client side, a dedicated device 174 such as a game device, or an IC chip 186 and executing the program in a CPU, the system having the above-described functions can be easily established. The program can be distributed, for example, through a communication line, or can be transferred as a package application which can be run on a stand-alone computer.

Further, this program may be stored in media 181 to 185 which can be read by a personal computer. To be specific, as shown in FIG. 11, the program may be stored in various storage media, for example, a magnetic recording medium such as a flexible disc 183 or a cassette tape 182, an optical disc 181 such as a CD-ROM or a DVD-ROM, a USB memory 185, or a memory card 184.

### Modification Example

Further, the present invention is not limited to the above-described embodiment and can be modified and changed in various ways. For example, in the above-described embodiment, the mobile terminal M1 is used when a return site is set. However, the vehicle-mounted terminal 6 may be used. In this case, position information is acquired from the GPS receiver 65b of the vehicle-mounted terminal 6 and also, the functional modules of the reservation setting unit 17b and the arrival time notifying unit 17c are established in the control unit 64.

Further, when a customer performs a manipulation for searching for a store as a return site, position information and a customer ID in the memory 66 are transmitted to the vehicle rental management server 2, and based on the position information, the return receiving unit 223b selects multiple stores that can be used for return and transmits such information to the vehicle-mounted terminal 6.

Furthermore, the navigation control unit 64c of the vehicle-mounted terminal 6 displays information about the stores that can be used for return on the display unit 63a. Thereafter, if a store as a return site is selected by manipulation of the customer, the navigation control unit 64c acquires information about the current position and calculates an estimated arrival time at the return site and notifies the vehicle rental management server 2 of the estimated arrival time and information about the store as the return site as arrival information.

Also, in the above-described embodiment, the arrival information notifying unit 17c calculates an estimated arrival time and transmits the time to the vehicle rental management server 2. However, for example, the vehicle rental management server 2 may calculate an estimated arrival time.

To be specific, the arrival information notifying unit 17c transmits position information and a store ID of the return site as a destination, and the return receiving unit 223b of the vehicle rental management server 2 calculates an estimated arrival time at the destination according to the destination of the vehicle and position information measured by the vehicle-mounted terminal 6 and acquires the calculated estimated arrival time and information about the set destination as arrival information. Further, based on the destination and the estimated arrival time included in the acquired arrival information, a vehicle rental reservation is set.

Furthermore, in the above-described embodiment, a clerk captures images of the vehicle body using the store terminal M3 during a return procedure. However, the present invention is not limited thereto, and for example, when the vehicle C enters into a parking space, a camera arranged in the parking space may automatically capture images of the vehicle and image data may be transmitted to the vehicle rental management server 2. In this case, the camera capturing images of the vehicle has the same function as the above-described camera 34 of the store terminal M3 and captures images of the vehicle body from multiple directions so as to correspond to the predetermined frame. Further, the camera transmits the image data to the vehicle rental management server 2 by way of wired or wireless communication.

Furthermore, a camera arranged in the parking lot may be arranged in each direction of the parking space, or a single camera may be configured to rotate at a bottom portion of the parking space and capture images of the vehicle body from every directions. In this case, by automatically capturing images of a vehicle, work load of the clerk who rents the vehicle C can be reduced and also, the store can be unmanned, thereby reducing the overall cost of the system.

Also, in the above-described embodiment, a key is kept in the key box in the vehicle. However, for example, a clerk of the store S may keep and manage the key to rent or collect the key to/from a customer.

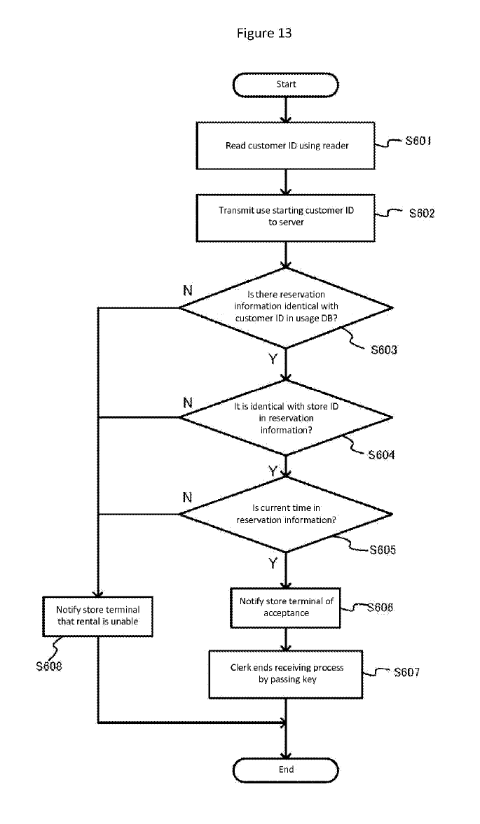

In this case, in the case of vehicle rental, as shown in FIG. 13, when a next customer U2 comes to the store S, the clerk reads a customer ID from the memory 15 of the mobile terminal M2 using the reader 8 (S601). Thereafter, if the clerk presses, for example, a rental procedure starting button displayed on the display unit 33a using the store terminal M3, a rental procedure manipulation signal, the acquired customer ID, and a store ID are transmitted to the vehicle rental management server 2 (S602).

If the comparison unit 228 of the vehicle rental management server 2 acquires the rental procedure manipulation signal, based on the customer ID acquired at the same time, the comparison unit 228 determines whether or not there is reservation information corresponding to the customer ID in the usage condition database 234 (S603). If there is no reservation information (“N” of S603), the store terminal M3 is notified of information indicating that rental is unavailable (S608). On the other hand, if there is reservation information (“Y” of S603), the acquired store ID is compared with a store ID included in the reservation information to determine whether or not the store IDs are identical with each other (S604). Herein, if the store IDs are not identical with each other (“N” of S604), the store terminal M3 is notified of information indicating that rental is not performed in this store (S608)

On the other hand, if the store IDs are identical with each other (“Y” of S604), the comparison unit 228 compares usage time information in the reservation information with time information acquired by the timing unit 24 to determine whether or not the current time is within an estimated usage time (S605) Herein, if the current time is not within an estimated usage time (“N” of S605), the store terminal M3 is notified of information indicating that the time is not available for rental (S608).

On the other hand, if the current time is within an estimated usage time (“Y” of S605), the store terminal M3 is notified of information indicating that a reserved vehicle can be rented (S606). In this case, based on the vehicle ID, the comparison unit 228 changes the content of the “usage condition” in the vehicle database. Thereafter, acceptance of rental is displayed on the screen of the display unit 33a of the store terminal M3, and the clerk passes the key of the vehicle C to a next customer U2 and ends the process in the store (S607).

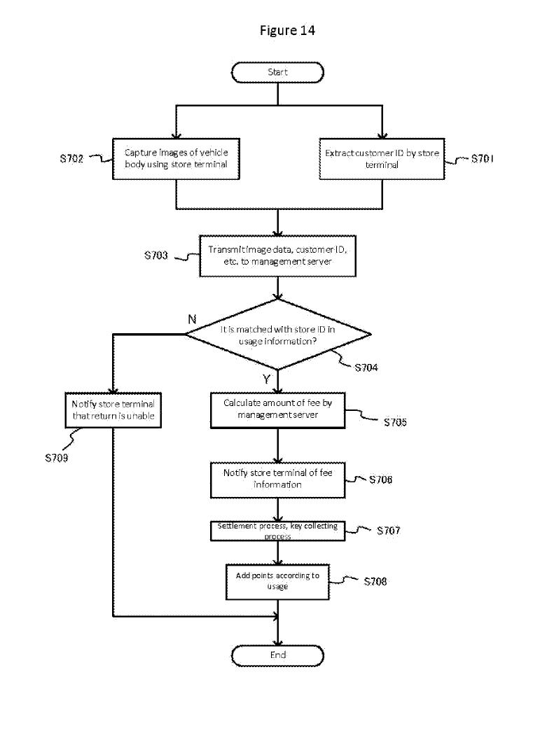

Further, in the case of vehicle return, as illustrated in FIG. 14, when the customer U1 comes to a store to return the vehicle C, the clerk reads a customer ID from the memory 15 of the mobile terminal M1 using the reader 8 (S701) and also captures images of the vehicle C with the camera 34 of the store terminal M3 while the vehicle rental management application is activated (S702). In this case, the clerk captures multiple images of the vehicle from preset directions so as to correspond to the frame for the vehicle displayed on the display unit 13a.

Further, if the clerk presses, for example, a return procedure starting button displayed on the display unit 33a using the store terminal M3, a return procedure manipulation signal, the read customer ID, the store ID, and the multiple image data are transmitted to the vehicle rental management server 2 (S703).

If the comparison unit 228 of the vehicle rental management server 2 acquires the return procedure manipulation signal, based on the customer ID acquired at the same time, the comparison unit 228 determines whether or not the store ID included in the reservation information is identical with the acquired store ID, with reference to usage information corresponding to the customer ID from the usage condition database 234 (S704).

If the store IDs are not identical with each other (“N” of S704), the store terminal M3 is notified of information indicating that return is not available in this store (S709). On the other hand, if the store IDs are identical with each other (“Y” of S704), the payment processing unit 227 calculates an amount of fees according to a usage time (S705) and transmits the fee information to the store terminal M3 (S706). In this case, with reference to the customer database 232, if the customer has points, the payment processing unit 227 may subtract the amount of fees according to the points. Further, the comparison unit 228 determines whether there is damage or contamination in the vehicle from the acquired image data by way of an image recognition process.

The store terminal M3 acquires such fee information and performs a settlement process and collects a key of the vehicle C (S707). In this case, the settlement information is transmitted to the vehicle rental management server 2, and the point management unit 229 calculates points according to a usage condition of this time and accumulates the points in the customer database (S708).

According to the present modification example, since the key is kept in the store, it is possible to verify whether the key is returned and also possible to prevent a loss of the key. Further, at the time of vehicle rental, an authentication process is performed at the store. Thus, it is possible to prevent the vehicle from being returned to another store.

Furthermore, in the above-described embodiment, the vehicle-mounted terminal 6 has a navigation function. However, in the present invention, preferably, a position information acquiring function using a GPS receiver and a door locking control function using the short distance wireless communication unit 67, the door locking control unit 64b, and the engine control unit 64a may be implemented without a navigation function. In this case, the number of components mounted in the vehicle can be reduced, thereby reducing the overall cost of the system.

<<Specific Example of Return Reservation>>

Hereinafter, a specific example of the above-described return reservation process and a modification example thereof will be described.

<Database>

Herein, there will be described a modification example of a database structure in the storage device 23 to be used for other processes of the return reservation. A specific example of a return reservation to be described below uses a database described herein.

<1> Database Configuration for Managing Condition of Parking Lot and Vehicle

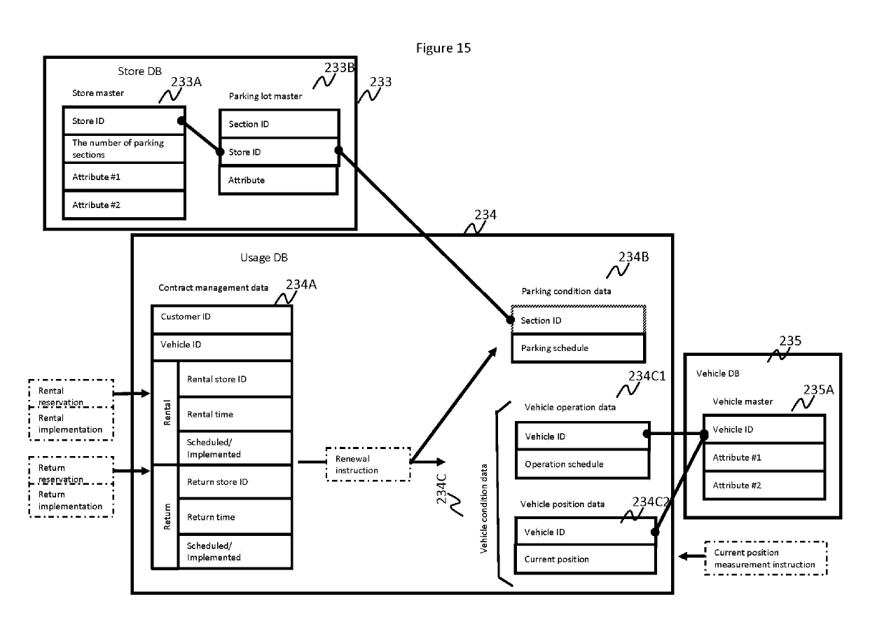

FIG. 15 is a diagram illustrating a configuration of main components in a modification example of a database structure of a storage device 23. In FIG. 15, a store database 233 includes a store master 233A and a parking lot master 233B. The usage condition database 234 includes contract management data 234A, parking condition data 234B, and vehicle condition data 234C. The vehicle condition data 234C include vehicle operation data 234C1 and vehicle position data 234C2. A vehicle database 235 includes a vehicle master 235A.

In the store master 233A, a store ID for identifying a store, the number of parking lots (parking sections) (the number of parking sections) present in the store, and various attributes (#1, #2) of the store are correlated with one another. Herein, examples of the attributes of the store may include a name of the store or a position of the store. In the parking lot master 233B, a section ID for identifying a parking section, a store ID of the store including the parking section, and an attribute of the parking section are correlated to one another. An example of the attribute may include a position of the parking section.

In the contract management data 234A, data about reservation setting for vehicle rental and data return or implementation of rental and return, i.e., data about which vehicle is rented or rental or return of which vehicle is reserved or implemented by which customer at which store are registered. If a new rental reservation is made, the contract management data 234A is renewed after implementation of rental, a return reservation, and implementation of return. Based on the data registered in the contract management data 234A, the parking condition data 234B and the vehicle condition data 234C are renewed.

In the reservation management data 234A, a vehicle ID of a vehicle reserved for rental is connected with a customer ID of a customer making a rental reservation. With respect to a combination of the customer ID and the vehicle ID, rental data and return data may be registered. The rental data is related to a rental reservation and implementation of rental, and the return data is related to a return reservation and implementation of return.

In the rental data, with respect to the combination of the customer ID and the vehicle ID, a rental store ID in connection with a rental time and classification into scheduled/implemented may be registered. The classification into scheduled/implemented shows whether or not rental is implemented, i.e., whether the data is data about implemented rental or data about scheduled rental. As the rental store ID, a store ID of the store (rental store) scheduled to implement rental or implementing rental is registered. As the rental time, a time scheduled to implement rental or implementing rental is registered.

In the return data, with respect to the combination of the customer ID and the vehicle ID, a return store ID in connection with a return time and classification into scheduled/implemented may be registered. The classification into scheduled/implemented shows whether or not return is implemented, i.e., whether the data is data about implemented return or data about scheduled return. As the return store ID, a store ID of the store (return store) scheduled to implement return or implementing return is registered. As the return time, a time scheduled to implement return or implementing return is registered. Further, herein, in the case where the return time is an estimated return time, such a case includes actually setting an estimated return time by combining a time and a period, such as from which day, how many hours, etc.

In the parking condition data 234B, a section ID and a parking schedule in the parking section are registered. The parking schedule refers to data about which time the parking section can be used, i.e., which time a vehicle can be returned to the parking section.

The vehicle condition data 234C includes the vehicle operation data 234C1 and the vehicle position data 234C2. The vehicle operation data 234C1 shows an operation schedule of each vehicle, and the vehicle position data 234C2 shows the current position of each vehicle. The operation schedule refers to data about which time each vehicle can be used, i.e., which time each vehicle can be rented. The operation schedule is renewed according to vehicle rental, setting of a return reservation, or implementation of rental or return.

Information of the current position of a vehicle in the vehicle position data 234C2 is renewed when the current position of the vehicle is measured.

In the vehicle master 235A, a vehicle ID and attributes (#1, #2) of each vehicle are correlated with one another. Examples of the attributes may include a class or a kind of a vehicle.

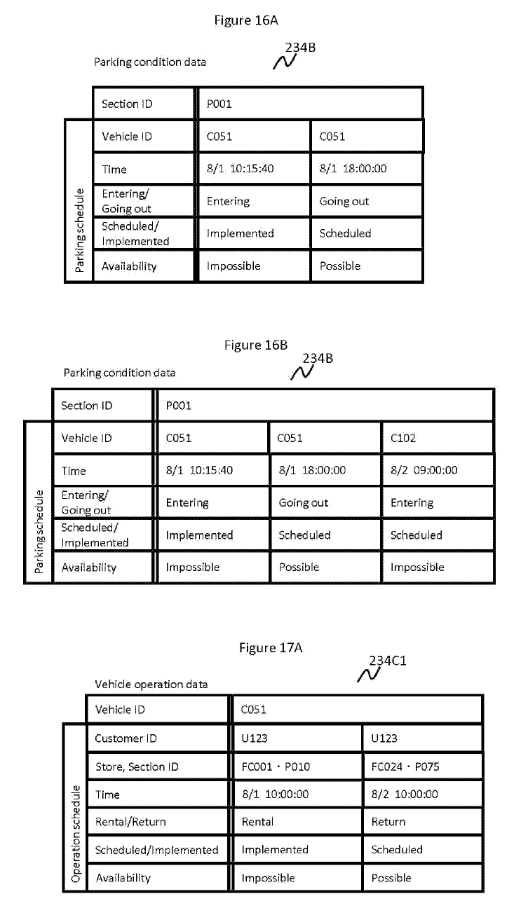

FIGS. 16A and 16B are diagrams each illustrating a registration example of parking condition data 234B.

In the parking condition data 234B, information that enables determination on which future time each parking section “can be used” in connection with a section ID of each parking section is recorded. Herein, the term “can be used” refers to a state in which a vehicle can be returned to a parking section. The information that enables determination on whether or not each parking section can be used refers to, for example, a prearranged parking schedule showing which vehicle enters or goes out at which time. Further, in the example illustrated herein, the information includes a future parking schedule and an implemented parking schedule in the past. “Implemented” in the classification into scheduled/implemented refers to a past parking schedule. The parking condition data 234B can be written based on the reservation management data 234A. For example, reservation and implementation of each rental and return are registered in the contract management data 234A, and based on the contract management data 234A, the parking condition data 234B are registered as being classified into scheduled/implemented.

Based on the parking condition data 234B, it is possible to determine whether or not the parking section “can be used” at a certain future time. For example, if the current time is 12 o'clock on August 1 and a parking schedule of a certain parking section is as shown in FIG. 16A, it can be determined that the parking section “can be used” after 18 o'clock on August 1. As such, if a store has a parking section to which any vehicle is not yet scheduled to enter after a certain time point, the store can be a target of a rental reservation.

Then, if there is a new entry schedule (return schedule) as shown in FIG. 16B, it can be determined that the parking section “can be used” in a time zone from 18 o'clock on August 1 to 9 o'clock on August 2. As such, if a store has a parking section which can be used in a limited time zone, determination on whether or not the store can be a target of a rental reservation may vary depending on a length of the time zone, conditions of other parking lots in the same store, or a business policy.

FIGS. 17A and 17B are diagrams each illustrating a registration example of vehicle operation data 234C1.

In the vehicle operation data 234C1, information that enables determination on which future time each vehicle “can be used” (in a state in which the vehicle can be rented) at which site (at which parking section) in connection with a vehicle ID of each vehicle is recorded. For example, if a prearranged operation schedule about to or from which customer a vehicle is scheduled to be rented or returned at which time and at which parking section is recorded in connection with a vehicle ID of each vehicle, such determination can be made. The vehicle operation data 234C1 can be written based on the contract management data 234A. For example, reservation and implementation of each rental and return are registered in the contract management data 234A, and based on the contract management data 234A, the vehicle operation data 234C1 are registered as being classified into scheduled/implemented.

In the example as shown in FIGS. 17A and 17B, a customer ID, a store ID, a section ID, a time, classification into rental/return, classification into scheduled/implemented, and availability in connection with a vehicle ID are registered. Further, according to this example, an operation schedule is recorded in the vehicle operation data 234C1 in a time sequential manner and an operation schedule implemented in the past is also included therein.

The customer ID refers to a customer ID of a customer scheduled to use a vehicle or already using the vehicle. The store ID and the section ID respectively refer to a store ID of a store at which vehicle rental or return is scheduled to be implemented or already implemented and a section ID of a parking section thereof. The time refers to a time at which vehicle rental or return is scheduled to be implemented or already implemented. The classification into rental/return shows whether vehicle rental or return is scheduled to be implemented or already implemented. The classification into scheduled/implemented shows whether rental or return is scheduled to be implemented or already implemented. The availability shows whether or not a vehicle can be used from a certain time point.

Based on the vehicle operation data 234C1, it is possible to determine at which parking section a vehicle can be rented at a certain future time. For example, if the current time is 12 o'clock on August 1 and an operation schedule of a certain vehicle is as shown in FIG. 17A, it can be determined that the vehicle can be used (can be rented) after 10 o'clock on August 2. However, if there is a new rental schedule (going-out schedule as shown in FIG. 17B, it can be determined that the vehicle cannot be used as long as a new return reservation is not received. Further, determination on whether or not the vehicle “can be used” in a time zone as shown in FIG. 17B, for example from 10 o'clock to 12 o'clock on August 2, in which the vehicle is not rented may vary depending on a length of the time zone or a business policy.

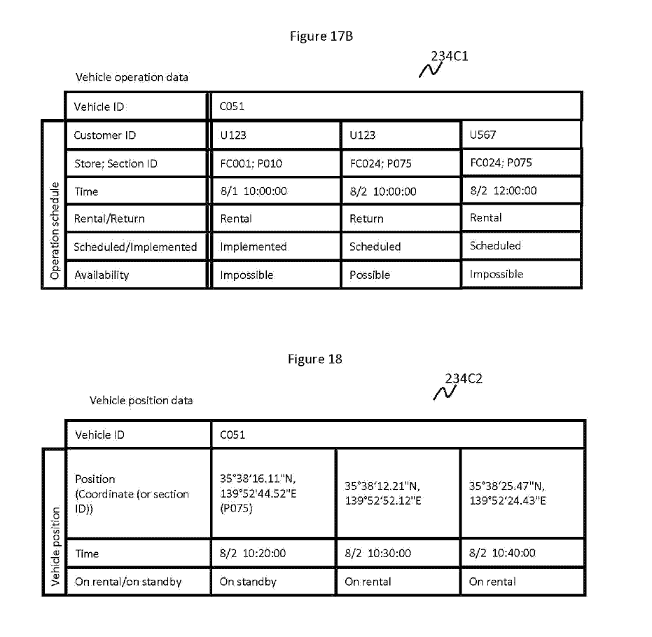

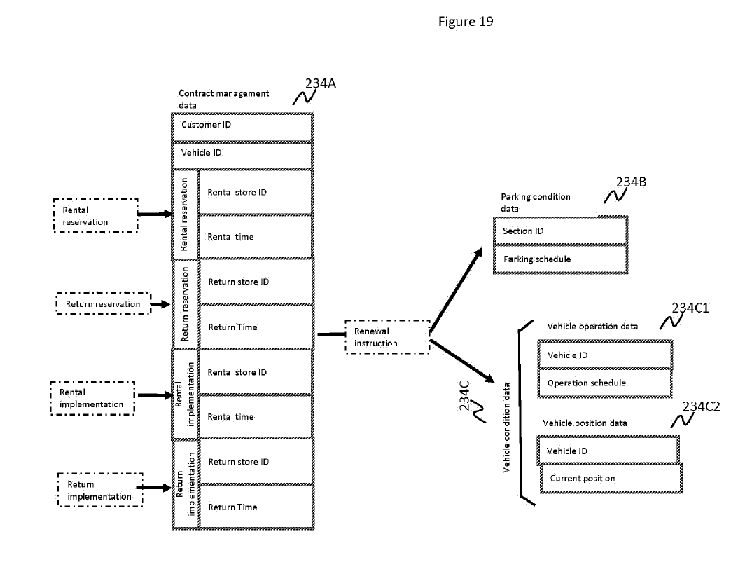

FIG. 18 is a diagram illustrating a registration example of vehicle position data 234C2.

In the vehicle position data 234C2, each time when a current position of each vehicle is measured and the position (current position) measured at that time are recorded in connection with a vehicle ID of each vehicle. The measurement of a current position and recording thereof are performed at least while each vehicle is rented. In the example as shown in FIG. 18, a position where a vehicle is on standby at a parking section is also recorded. In this case, the position may be expressed by coordinates or a section ID of the parking section. A position of a vehicle can be measured regularly or when necessary such as when a rental reservation is received as described below. A position of a vehicle is expressed by, for example, latitude and longitude coordinates.

Further, the configuration of the usage condition database 234 shown in FIG. 15 is an example and can be modified and changed in various ways. For example, in FIG. 15, with respect to each rental and return, reservation and implementation is classified into reserved/implemented and managed in the same field. However, reservation and implementation may be respectively registered and managed in separate fields.

FIG. 19 is a diagram provided to explain a modification example of a usage condition database. In the modification example as shown in FIG. 19, in the contract management data 234A, with respect to a combination of the customer ID and the vehicle ID, rental reservation data, return reservation data, and rental implementation data, and return implementation data can be registered.

In the rental reservation data, a store ID of a store scheduled to implement rental and a time at which rental is scheduled to be implemented according to a rental reservation are recorded. In the return reservation data, a store ID of a store scheduled to implement return and a time at which return is scheduled to be implemented according to a return reservation are recorded. In the rental implementation data, regarding actually implemented rental, a store ID of a store implementing the rental and a time at which the rental is implemented are recorded. In the return implementation data, regarding actually implemented return, a store ID of a store implementing the return and a time at which the return is implemented are recorded.

The reservation for rental or return and the actual implementation thereof are separately managed. Thus, the fields indicating scheduled/implemented as shown in FIG. 15 become unnecessary.

Further, for example, in FIG. 15, reservation and implementation of each of rental and return are registered into the contract management data 234A, and based on the contract management data 234A, the parking condition data 234B and the vehicle operation data 234C1 are registered as being classified into scheduled/implemented. However, reservation and implementation may be directly registered into the parking condition data 234B and the vehicle operation data 234C1.

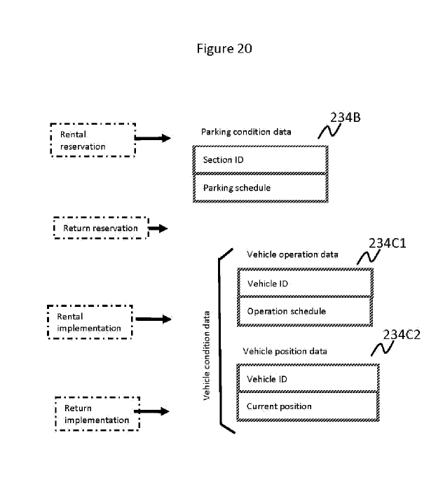

FIG. 20 is a diagram provided to explain another modification example of a usage condition database. In the modification example as shown in FIG. 20, if a rental reservation, a return reservation, a rental implementation, and a return implementation occur, reservation and implementation are be classified and directly registered into the parking condition data 234B and the vehicle operation data 234C1 without passing through the contract management data 234A.

<Whole Return Reservation Process>

In the following descriptions of the process, a mobile terminal or a vehicle-mounted terminal may be referred to as a customer terminal. A mobile terminal to be used for a return reservation is a mobile terminal M1 of a customer U1 who is currently renting a vehicle.

<First Example of Whole Return Reservation Process>

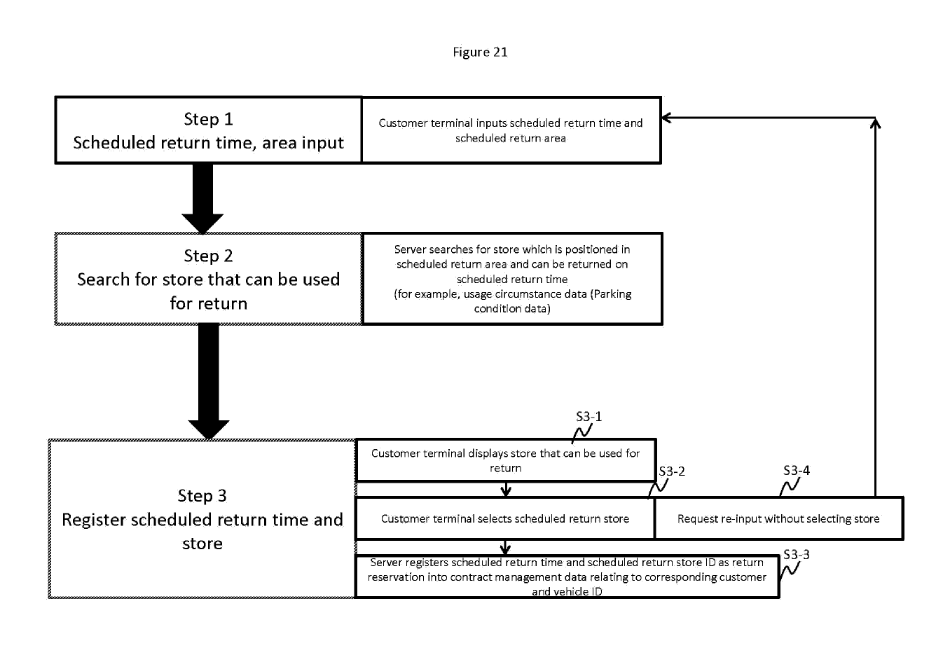

FIG. 21 is a flow chart illustrating a first example of the whole return reservation process. The first example shows a process in which a return time is prioritized and the return time and a return site are set at the same time.

In step 1, a desired return time and a desired return area are inputted. In step 1, by manipulation of a customer who rents a vehicle, a customer terminal inputs a desired return time and a desired return area.

A method of inputting a scheduled return time and a scheduled return site is freely determined by the customer. Further, based on any one of the scheduled return time and the scheduled return site and the current site of the vehicle, the customer terminal or the vehicle rental management server 2 may calculate the other one. This is the same as the whole return reservation process in the other example to be described below.

In the latter inputting method, when a scheduled return time is determined, a reachable distance range from the current position from the current time to the scheduled return time is estimated based on map data, and the customer may select a scheduled return area from the distance range. Otherwise, when a scheduled return area is determined, a reachable time from the current position to the scheduled return area is estimated, and the customer may select a scheduled return time from a time range after such a time point.

In determining the scheduled return area, an area is directly designated and a representative position such as a facility, an address, or a store is designated such that a neighboring area of the representative position can be indirectly designated. Further, the representative position is designated by the customer, and also, the current position measured by a GPS or the like of the terminal can be the representative position. As the scheduled return area, desired one or two or more stores may be specifically specified. This is the same as the whole return reservation process in the other example to be described below.

In step 2, an available store is searched for. In step 2, the vehicle rental management server 2 searches for a store which is positioned in the desired return area and can be used at the desired return time, and notifies the customer terminal of the searched store. For example, the parking condition data 234B of the usage condition database 234 may be searched.

In this case, the vehicle rental management server 2 may do a search automatically or according to manipulation of an operator from a vehicle rental management company. Further, the customer terminal may acquire store condition data from the vehicle rental management server 2 and do a search instead of the vehicle rental management server 2. This is the same as the whole return reservation process in the other example to be described below.

In this case, a store outputted as a search result may be limited to be at a reachable position from the current position by the scheduled return time. This is the same as a search for an available store during the whole return reservation process in the other example to be described below.

In step 3, a usage return time and attachment are registered. Step 3 includes step 3-1 to step 3-4.

In step 3-1, the customer terminal displays available stores. Then, in step 3-2, the customer manipulates the customer terminal to select a desired return store from the available stores. Then, in step 3-3, the vehicle rental management server 2 registers a desired return time and a desired return store ID, as return reservation data relating to the customer and the vehicle ID, and an estimated return time and an estimate return store in the contract management data 234A. The registration of the estimated return time and the estimate return store includes recording a return time and a return store ID in the contract management data 234A and sets a scheduled/implemented section to be scheduled.

After step 3-1, if the customer performs manipulation intending to request re-input without performing an operation of selecting a functional return store, the customer terminal returns to step 1.

<Second Example of Whole Return Reservation Process>

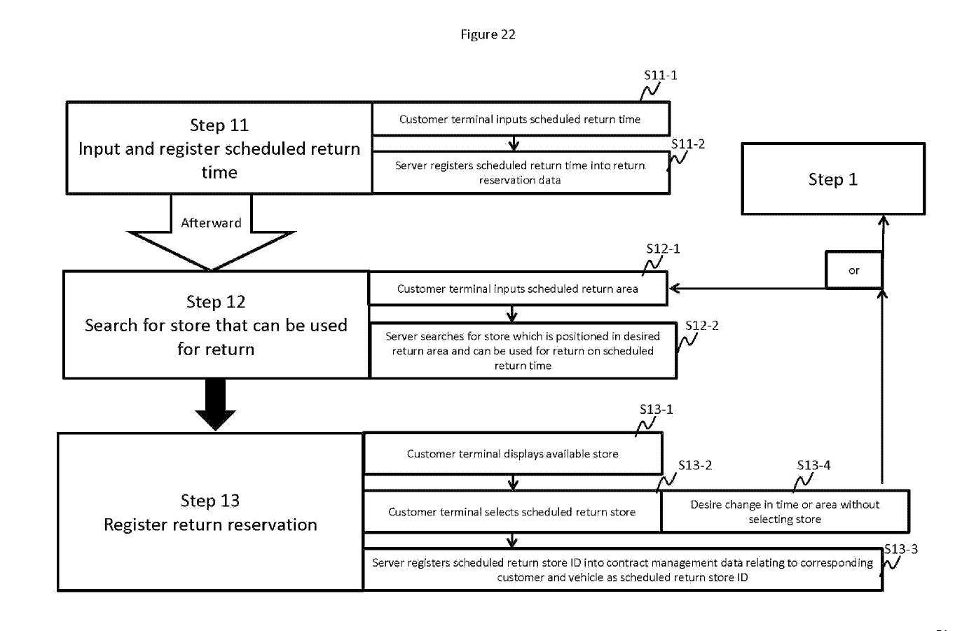

FIG. 22 is a flow chart illustrating a second example of the whole return reservation process. The second example shows a process in which a return time is preferentially set.

In step 11, an estimated return time is inputted and registered. Step 11 includes steps 11-1 and 11-2. In step 11-1, a customer who rents a vehicle manipulates the customer terminal to first input only an estimated return time. The inputted information of the estimated return time is notified to the vehicle rental management server 2. In step 11-2, the vehicle rental management server 2 registers the estimated return time as return reservation data in the contract management data 234A.

In step 12, a store that can be used for return is searched for. Step 12 includes steps 12-1 and 12-2. In step 12-1, the customer terminal inputs an estimated return area according to the manipulation by the customer separately performed after step 11. The inputted estimated return area is notified to the vehicle rental management server 2. Then, in step 12-2, the vehicle rental management server 2 positioned in the desired return area searches for a store (which can be used) that suits the estimated return time. The information of the available store obtained through a search is notified to the customer terminal.

In step 13, a return reservation is registered. Step 13 includes step 13-1 to step 13-4. In step 13-1, the customer terminal displays available stores. Then, in step 13-2, the customer manipulates the customer terminal to select an estimated return store among the available stores. In step 13-3, an estimated return store ID which is the information of an estimated return store is registered in the contract management data 234A relating to the customer and the vehicle by the vehicle rental management server 2. Meanwhile, after step 13-1, if the customer desires to change a time or an area without performing the operation of selecting an estimated return store, the customer terminal returns to step 1 or to step 12-1. In this case, if the customer desires to change a time, the customer terminal may return to step 1, and if the customer desires to change an area, the customer terminal may return to step 12-1.

<Third Example of Whole Return Reservation Process>

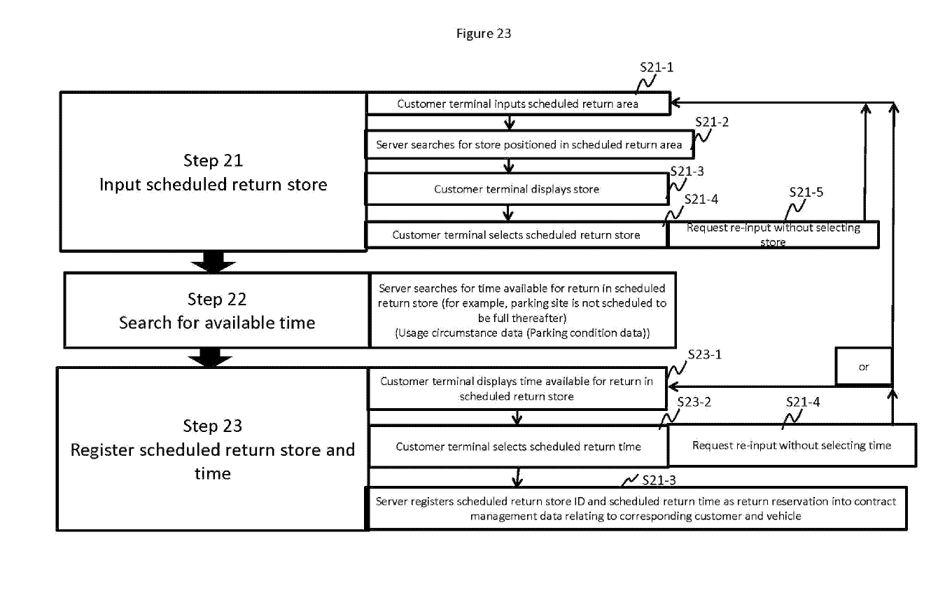

FIG. 23 is a flow chart illustrating a third example of the whole return reservation process. The third example shows a process in which a return store is prioritized and a return time and the return site are set at the same time.

In step 21, an estimated return store is inputted. Step 21 includes steps 21-1 to 21-5. In step 21-1, by manipulation of the customer who rents a vehicle, the customer terminal inputs an estimated return area. The inputted information of the estimated return area is notified to the vehicle rental management server 2. In step 21-2, the vehicle rental management server 2 searches a store positioned in the estimated return area. The information of the available store obtained from a search is notified to the customer terminal. In step 21-3, the customer terminal displays stores obtained from a search by the vehicle rental management server 2. In step 21-4, the customer viewing the display manipulates the customer terminal to select an estimated return store among the displayed stores. Meanwhile, as shown in step 21-5, if the customer does not select any store, the customer terminal returns to step 21-1. Further, if a store in the estimated return area is specifically selected in step 21-1, steps 21-2 to 21-4 are not necessary.

In step 22, a return available time is searched for. In step 22, the vehicle rental management server 2 searches for a time available to return a vehicle (an available return time) to the estimated return store and notifies this to the customer terminal. Herein, for example, the vehicle rental management server 2 searches the parking condition data 234B of the usage condition data 234. It can be determined that, for example, after the available return time, a parking lot is not scheduled to be full. Further, in this case, the available return time may be limited to a time in a reachable time range (after which time) from the current position to the estimated return store. This is the same in the modification example to be described below.

In step 23, an estimated return store and an estimated return time are registered. Step 23 includes steps 23-1 to 21-4. In step 23-1, the customer terminal displays the several available return times at the estimated return store. Then, the customer viewing the display manipulates the customer terminal to select an estimated return time among the available return times. The selected result is notified to the vehicle rental management server 2. Then, in step 23-3, the vehicle rental management server 2 registers a store ID of the estimated return store and the estimated return time into the contract management data 234A relating to the customer and the vehicle, as a return reservation. Meanwhile, after step 23-1, if the customer requests re-input without performing an operation of selecting an estimated return time as shown in step 23-4, the customer terminal returns to step 23-1 or step 21-1 according to the customer's request.

<Fourth Example of the Whole Return Reservation Process>

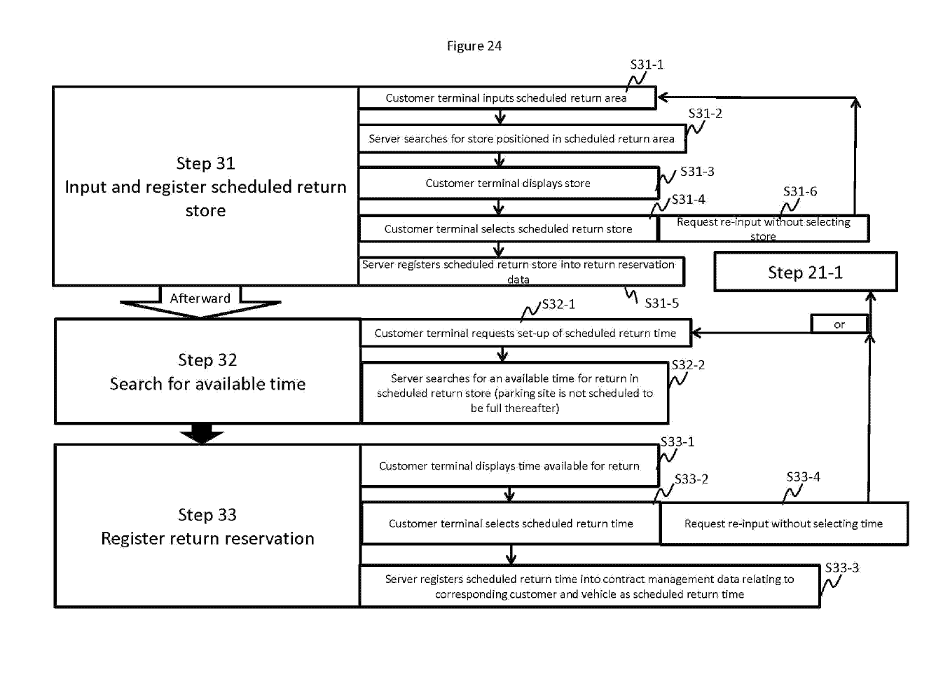

FIG. 24 is a flow chart illustrating a fourth example of the whole return reservation process. The fourth example shows a process in which a return store is preferentially set.

In step 31, an estimated return store is inputted and registered. Step 31 includes steps 31-1 to 21-6. In step 31-1, a customer renting a vehicle firstly manipulates the customer terminal to input an estimated return area. The inputted information of the estimated return area is notified to the vehicle rental management server 2. In step 31-2, the vehicle rental management server 2 searches for stores in the estimated return area and notifies the obtained information of the stores to the customer terminal. In step 31-3, the customer terminal displays the notified stores. Then, in step 31-4, the customer manipulates the customer terminal to select an estimated return store among the displayed stores. The information of the selected estimated return store is notified to the vehicle rental management server 2. In step 31-5, the vehicle rental management server 2 registers the estimated return store into the contract management data 234A as return reservation data. Meanwhile, after step 31-3, if a customer requests re-input without performing a selecting operation of an estimated return store, the customer terminal returns to step 31-1 as is the case with step 31-6.

In step 32, an available return time is searched for. Step 32 includes steps 32-1 and 31-2. In step 32-1, the customer terminal requests the vehicle rental management server 2 to set an estimated return time according to a customer's manipulation performed after step 31 which separates step 31 and step 32-1. In step 32-2, the vehicle rental management server 2 searches for a time at which a vehicle can be returned to an estimated return store (an available return time). For example, the available return time may be set to a time when a parking lot is not scheduled to be full after that time. The information of the available return time obtained from a search is notified to the customer terminal.

In step 33, a return reservation is registered. Step 33 includes steps 33-1 to 33-4. In step 33-1, the customer terminal displays available return times. Then, in step 33-2, the customer viewing the display manipulates the customer terminal to select an estimated return time among the available return times. The selected estimated return time is notified to the vehicle rental management server 2. The vehicle rental management server 2 registers the notified estimated return time into the contract management data 234A relating to the customer and the vehicle as an estimated return time. Meanwhile, after step 33-1, if s customer requests re-input without performing a selecting operation of an estimated return store, the customer terminal returns to step 32-1 or step 21-1 according to the customer's request.

<<Specific Example of Actual Return without Return Reservation>>

As a method of returning a vehicle, a vehicle can actually be directly returned to a vacant parking section of a store whenever a customer wants without making a return reservation as described above. This will be referred to as “the direct return”.

In the direct return, a customer actually finds a store having a vacant parking section and parks the vehicle in the parking section. In this case, a process is performed such that the vehicle rental management server 2 confirms a fact that both or at least one of the customer and the vehicle is at the parking section.

A first aspect of the confirmation process will be described.

By bringing the mobile terminal M1 carried by the customer (or the vehicle-mounted terminal 6 installed in the vehicle) into connection (near field communication) with the store terminal M3 installed in the store, a terminal ID of one terminal is transmitted to the other terminal. The other terminal transmits, to the vehicle rental management server 2, IDs of the two terminals and a notice to actually perform return. The information transmitted in this case will be referred to as “first information”.

In short, based on the fact that the store terminal M3 (or the parking site terminal) is close to the mobile terminal M1 (or the vehicle-mounted terminal 6), the vehicle rental management server 2 can presume the fact that the customer and the vehicle are at the parking site (the fact of actual return) as accurately as possible not to actually cause a business problem.

A second aspect of the confirmation process will be described.

When the mobile terminal M1 or the vehicle-mounted terminal 6 transmits, to the vehicle rental management server 2, a notice to actually perform return, the current position of the terminal (measured by, for example, a GPS) is notified to the vehicle rental management server 2. The information transmitted in this case will be referred to as “second information”. If the position where the notice is transmitted is a parking section (parking space) of a certain store, the vehicle rental management server 2 can presume the fact that the vehicle is actually returned to the parking site as accurately as possible not to actually cause a business problem.

Further, any one of the mobile terminal M1, the vehicle-mounted terminal 6, and the store terminal (parking space terminal) M3 may transmit the first information or the second information to the vehicle rental management server 2.

If the vehicle rental management server 2 receives the first or second information, the vehicle rental management server 2 confirms the fact of actual return from the information and specifies which parking site is the actual return place, which customer is the customer who returned the vehicle, and which vehicle is the returned vehicle, with reference to the database. Further, the vehicle rental management server 2 specifies the return time based on the notified time. Furthermore, the vehicle rental management server 2 registers the specified information as the actual return data into the contract condition data 234A.

Also, herein, the store terminal M3 is not only limited to a terminal installed in a common vehicle rental store with a clerk, and may be, for example, an unmanned parking space terminal installed in each parking section or each parking facility including multiple parking sections. The store ID is not limited to the ID of the store, and may be a parking section or the ID of a parking section. This is applied to first to fourth examples of the whole process to be described below.

<First Example of Whole Process for the Direct Return>

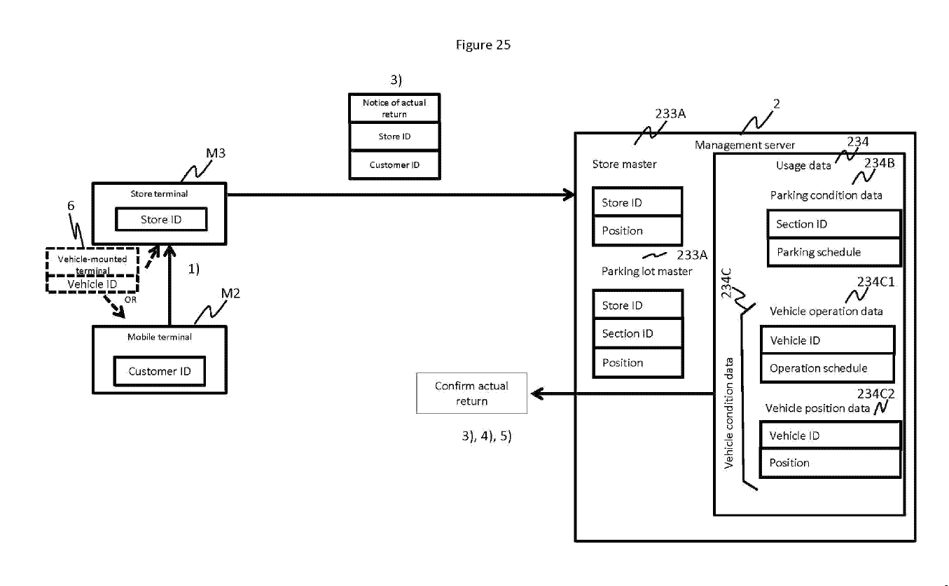

FIG. 25 is a diagram provided to explain a first example of the whole process for the direct return. The first example shows a process using near-field communication between the store terminal M3 and the mobile terminal M1. This is the specific example of the first aspect of the above-described confirmation process.

1) Firstly, by way of near-field communication between the customer's mobile terminal M1 and the store terminal M3, a customer ID is transmitted from the mobile terminal M1 to the store terminal M3. Thus, it is guaranteed that the mobile terminal M1 and the store terminal M3 are in the same store (or in the same parking section). For example, when a clerk causes the store terminal M3 to come close to a customer's mobile terminal M1 or when a customer puts the mobile terminal M1 on the store terminal M3, non-contact near-field communication is carried out. Further, by using near-field communication between the vehicle-mounted terminal 6 and the mobile terminal M1 and/or the store terminal M3 or using other methods, a vehicle ID may also be transmitted to the store terminal M3.

2) Then, the store terminal M3 transmits a notice of actual return including the store ID and the customer ID to the vehicle rental management server 2.

3) Then, when receiving the notice of actual return including the store ID and the customer ID from the store terminal M3, the vehicle rental management server 2 recognizes that the return is actually implemented in the store and also specifies the return time. For example, the return time can be specified based on a time to carry out communication with the store terminal M3 or a return time notified from the store terminal M3.

4) Then, the vehicle rental management server 2 specifies a customer returning a vehicle based on the received customer ID.

5) Then, the vehicle rental management server 2 specifies vehicles which have been rented to the customer based on the vehicle operation data 234C1 of the usage condition database 234. Such a specified vehicle is recognized as the returned vehicle. Further, if the vehicle ID is also received as described above, the returned vehicle may be specified using the vehicle ID.

Furthermore, the returned vehicle may be finally determined by performing an additional confirmation process as follows for accuracy.

The vehicle rental management server 2 sends characteristics (registration number, etc.) of the specified vehicle to the store terminal M3 or the mobile terminal M1 so that the clerk or the customer confirms that the vehicle is correct.

The vehicle rental management server 2 communicates with the vehicle-mounted terminal 6 of the specified vehicle to acquire the current position thereof, and verifies whether the current position thereof is identical with the position of the store (or the parking section or the parking facility) having the received store ID.

Although the store terminal M3 transmits the notice of actual return to the vehicle rental management server 2 in the above-described example, a terminal that transmits the notice of actual return to the vehicle rental management server 2 is not necessarily limited to the store terminal M3 and may be the mobile terminal M1 or the vehicle-mounted terminal 6. This is the same in second to fourth examples to be described below.

<Second Example of Whole Process for the Direct Return>

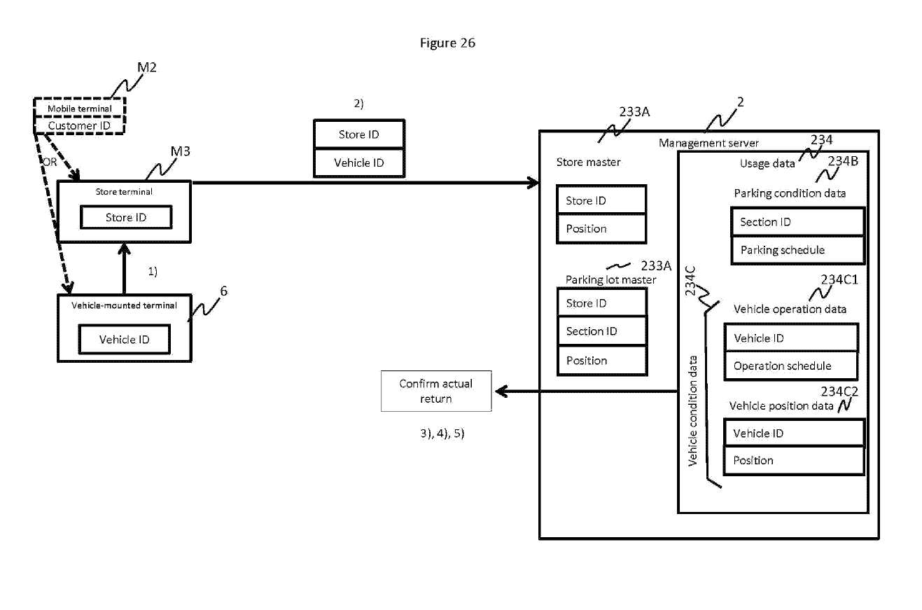

FIG. 26 is a diagram provided to explain a second example of the whole process for a direct return. The second example shows a process using near-field communication between the store terminal M3 and the mobile terminal M1. This is a specific example other than the first aspect of the above-described confirmation process.

1) Firstly, by way of near-field communication between the vehicle-mounted terminal 6 of the vehicle and the store terminal M3, a vehicle ID is transmitted from the vehicle-mounted terminal 6 to the store terminal M3. Thus, it is guaranteed that the vehicle-mounted terminal 6 and the store terminal M3 are in the same store (or in the same parking section). For example, when the vehicle comes to the store, the store terminal M3 acquires the vehicle ID from the vehicle-mounted terminal 6 by way of short distance wireless communication. Further, by using near-field communication between the mobile terminal M1 and the vehicle-mounted terminal 6 and/or the store terminal M3 or using other methods, a customer ID may also be transmitted to the store terminal M3.

2) Then, the store terminal M3 transmits a notice of actual return including the store ID and the vehicle ID to the vehicle rental management server 2.

3) Then, when receiving the notice of actual return including the store ID and the vehicle ID from the store terminal M3, the vehicle rental management server 2 recognizes that the return is actually implemented in the store and also specifies a return time. For example, the return time can be specified based on a time to carry out communication with the store terminal M3 or a return time notified from the store terminal M3.

4) Then, the vehicle rental management server 2 specifies the returned vehicle based on the received vehicle ID.

5) Then, the vehicle rental management server 2 specifies a customer renting the vehicle based on the vehicle operation data 234C1 of the usage condition database 234. Such a specified customer is recognized as the customer who has completed the vehicle return. Further, if the customer ID is also received as described above, the customer returning the vehicle may be specified using the customer ID.

Furthermore, the customer returning the vehicle may be finally determined by performing an additional confirmation process as follows for accuracy.

The vehicle rental management server 2 sends characteristics (name, etc.) of the specified customer to the store terminal M3 or the mobile terminal M1 so that a clerk or the customer confirms that the customer is correct.

The vehicle rental management server 2 communicates with the mobile terminal M1 of the specified customer to acquire the current position thereof, and verifies whether the current position thereof is identical with a position of the store (or the parking section or the parking facility) having the received store ID.

<Third Example of Whole Process for the Direct Return>

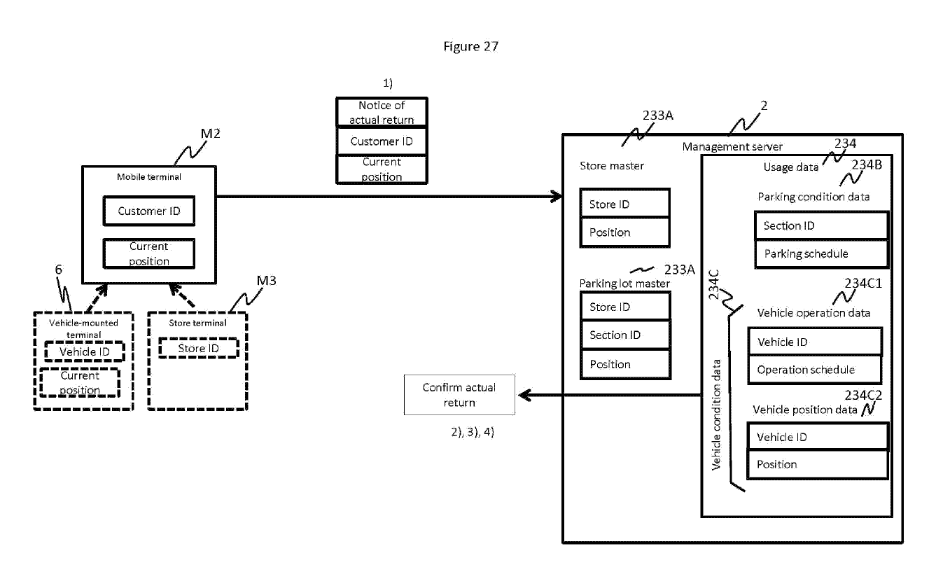

FIG. 27 is a diagram provided to explain a third example of the whole process for the direct return. The third example shows a process using a current position of the mobile terminal or the vehicle-mounted terminal. This is a specific example of a second aspect of the above-described confirmation process.

1) A customer ID and a notice of actual return including the customer (mobile terminal M1)'s current position measured (by the GPS, etc.) is transmitted from the mobile terminal M1 of the customer to the vehicle rental management server 2. Further, the mobile terminal M1 may acquire a vehicle ID and/or the current position of the vehicle by way of near-field communication with the vehicle-mounted terminal 6, and/or may acquire a store ID by way of near-field communication with the store terminal M3 and may include such information in the notice of actual return so as to be transmitted to the vehicle rental management server 2. Furthermore, instead of directly transmitting the notice of actual return from the mobile terminal M1 to the vehicle rental management server 2, the notice of actual return may be transmitted from the mobile terminal M1 to the vehicle rental management server 2 via the vehicle-mounted terminal 6 or the store terminal 3.

2) Then, based on the current position included in the notice of actual return, the vehicle rental management server 2 checks which store corresponds to the current position, or which parking section or which parking facility including multiple parking sections corresponds to the current position with reference to the store master 233A or the parking lot master 233B.

As a result, if it is confirmed that the mobile terminal M1 is located at a certain store, the vehicle rental management server 2 recognizes that the return is actually implemented and also specifies a return time. For example, the return time can be specified based on a time to carry out communication with the mobile terminal M1 or a return time notified from the mobile terminal M1.

3) Then, the vehicle rental management server 2 specifies a customer returned a vehicle based on the received customer ID.

4) Then, the vehicle rental management server 2 specifies vehicles which have been rented to the customer based on the vehicle operation data 234C1 of the usage condition database 234. Such a specified vehicle is recognized as the returned vehicle. Further, if the vehicle ID is also received as described above, the returned vehicle may be specified using the vehicle ID.

Furthermore, the returned vehicle may be finally determined by performing the additional confirmation process as described in the first and second examples for accuracy.

<Fourth Example of Whole Process for the Direct Return>

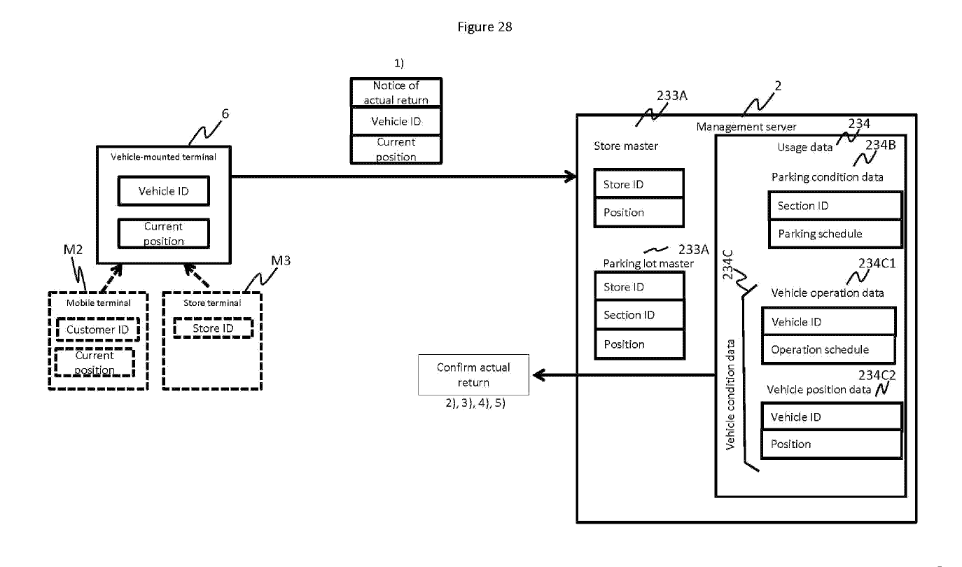

FIG. 28 is a diagram provided to explain a fourth example of the whole process for the direct return. The fourth example shows a process using a current position of the mobile terminal or the vehicle-mounted terminal. This is another specific example of the second aspect of the above-described confirmation process.

1) A vehicle ID and a notice of actual return including the vehicle's current position measured (by the GPS, etc.) is transmitted from the vehicle-mounted terminal 6 of the vehicle to the vehicle rental management server 2. Further, the vehicle-mounted terminal 6 may acquire a customer ID and/or the current position of the customer by way of near field communication with the mobile terminal M1, and/or acquire a store ID by way of near field communication with the store terminal M3 and include such information in the notice of actual return so as to be transmitted to the vehicle rental management server 2. Furthermore, instead of directly transmitting the notice of actual return from the vehicle-mounted terminal 6 to the vehicle rental management server 2, the notice of actual return may be transmitted from the vehicle-mounted terminal 6 to the vehicle rental management server 2 via the mobile terminal M1 or the store terminal M3.

2) Then, based on the current position included in the notice of actual return, the vehicle rental management server 2 checks which store corresponds to the current position, or which parking section or which parking facility including multiple parking sections corresponds to the current position with reference to the store master 233A or the parking lot master 233B.

As a result, if it is confirmed that the vehicle-mounted terminal 6 is located at a certain store, the vehicle rental management server 2 recognizes that the actual return is implemented and also specifies a return time. For example, the return time can be specified based on a time to carry out communication with the vehicle-mounted terminal 6 or a return time notified from the vehicle-mounted terminal 6.

3) Then, the vehicle rental management server 2 specifies a returned vehicle based on the received vehicle ID.

4) Then, the vehicle rental management server 2 specifies a customer renting the vehicle based on the vehicle operation data 234C1 of the usage condition database 234. Such a specified customer is recognized as the customer who has completed the vehicle return. Further, if the customer ID is also received as described above, the customer returning the vehicle may be specified using the customer ID.

Furthermore, the customer finally returning the vehicle may be determined by performing the additional confirmation process as described in the first and second examples for accuracy.

<<Method for Specifying Customer and Vehicle Related to Return Reservation or the Direct Return>>

The above-described return reservation process or the direct return process includes the process for specifying a customer who makes a return reservation or implements the direct return, and a vehicle subject to return reservation or the direct return. Herein, a specific example of the method for specifying a customer and a vehicle related to return reservation or the direct return will be described.

As described above, in the return reservation or the direct return process, the vehicle rental management server 2 may first communicate with the mobile terminal M1 and may first communicate with the vehicle-mounted terminal 6. For this reason, each case has an aspect of the basic process for specifying a customer and a vehicle.

In a first aspect of a process for specifying a customer and a vehicle, if the vehicle rental management server 2 first communicates with the mobile terminal M1, the vehicle rental management server 2 specifies a customer based on a signal from the mobile terminal with which the vehicle rental management server 2 first communicates. Further, the vehicle rental management server 2 specifies a vehicle being rented to the customer using, for example, a customer ID of the customer as a key with reference to the usage condition database 234.

In a second aspect of a process for specifying a customer and a vehicle, if the vehicle rental management server 2 first communicates with the vehicle-mounted terminal 6, the vehicle rental management server 2 specifies a vehicle based on a signal from the vehicle-mounted terminal 6 with which the vehicle rental management server 2 first communicates. Further, the vehicle rental management server 2 specifies a customer renting the vehicle, for example, the vehicle ID of the vehicle as a key with reference to the usage condition database 234.

In the methods for specifying a customer and a vehicle according to the first and second aspects, an additional confirmation process may be performed for more accuracy. Examples of the additional confirmation process are as follows.

The current position of the mobile terminal M1 is compared with the current position of the vehicle-mounted terminal 6.

The vehicle rental management server 2 transmits a specific result to the terminal with which the vehicle rental management server 2 first communicates to confirm the specific result to a customer.

The vehicle rental management server 2 communicates with the terminal with which the vehicle rental management server 2 first communicated to confirm whether a partner terminal of the terminal is a terminal to be subsequently specified.

The vehicle rental management server 2 communicates with the terminal to be subsequently specified to confirm whether a partner terminal of the terminal is the terminal with which the vehicle rental management server 2 first communicated.

Specific examples of various processes for specifying a customer and a vehicle such as the process including the basic process and the additional process, modification examples thereof, and other processes will be described as follows. First to eighth examples are about a case where the vehicle rental management server 2 first communicates with the mobile terminal M1, and ninth to sixteenth examples are about a case where the vehicle rental management server 2 first communicates with the vehicle-mounted terminal 6.

<First Example of Process for Specifying Customer and Vehicle>

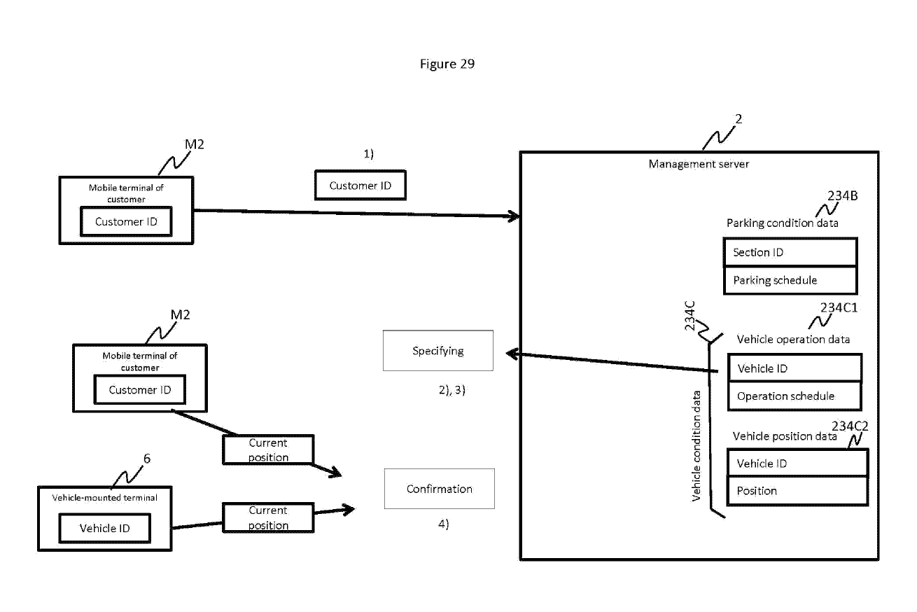

FIG. 29 is a diagram provided to explain a first example of the process for specifying a customer and a vehicle. The first example shows a basic method for specifying the target customer and the vehicle based on information from the mobile terminal M1.

1) Firstly, the mobile terminal M1 transmits a customer ID to the vehicle rental management server 2.

2) The vehicle rental management server 2 receives the customer ID of a customer using the mobile terminal M1 from the mobile terminal M1.

3) Then, the vehicle rental management server 2 specifies a vehicle ID of a vehicle being rented to the customer having the received customer ID with reference to the usage condition database 234. Herein, particularly, the vehicle operation data 234C1 of the vehicle condition data 234C showing which vehicle is rented to which customer are referred to.

As such, the customer and the vehicle are specified. In order to reduce mistakes, an additional confirmation process as described in paragraph 4) may be performed.

4) For example, the vehicle rental management server 2 may receive the current positions of the mobile terminal M1 and the vehicle-mounted terminal 6 having the vehicle ID and check whether the both current positions are actually identical with each other.

<Second Example of the Process for Specifying Customer and Vehicle>

In the second example, a customer and a vehicle are specified by the same processes as shown in paragraphs 1) to 3) of the first example, but an additional confirmation process is different from the process described in paragraph 4) of the first example.

1) The mobile terminal M1 transmits a customer ID to the vehicle rental management server 2.

2) The vehicle rental management server 2 receives the customer ID from the mobile terminal M1.

3) Then, the vehicle rental management server 2 specifies a vehicle ID of a vehicle being rented to the customer having the received customer ID with reference to the vehicle condition data 234C.

So far, the second example is the same as the first example.

4) The vehicle rental management server 2 acquires a certain attribute of the vehicle corresponding to the specified vehicle ID with reference to the vehicle master 235A and transmits the attribute to the mobile terminal M1 and notifies the customer of the attribute to confirm the vehicle to the customer. The attribute to be confirmed to the customer may include, for example, a registration number, a kind of the vehicle, or the like. In this case, if there are multiple specified vehicle IDs, these IDs may be transmitted to the mobile terminal M1, so that the customer may select any one vehicle.

5) The mobile terminal M1 displays the notified attribute, and the customer manually inputs a confirmation result into the mobile terminal M1. In this case, if multiple vehicle IDs are displayed, the customer selects one of them. A confirmation result or a selection result of the customer is notified to the vehicle rental management server 2 from the mobile terminal M1.

6) The vehicle rental management server 2 registers, as a vehicle ID of a vehicle subject to return reservation or actual return, the vehicle ID checked by the customer or the vehicle ID of the vehicle selected by the customer in the contract management data 234A of the usage condition database 234.

<Third Example of the Process for Specifying Customer and Vehicle>

In the third example, a customer is specified based on a customer ID from the mobile terminal M1 and a vehicle is specified with reference to the usage condition database 234 in the same manner as shown in paragraphs 1) to 3) of the first example, but the vehicle-mounted terminal 6 performs the confirmation process at that time.

1) The mobile terminal M1 transmits a customer ID to the vehicle rental management server 2.

2) The vehicle rental management server 2 receives the customer ID from the mobile terminal M1.

3) Then, the vehicle rental management server 2 specifies a vehicle ID of a vehicle being rented to the customer having the received customer ID with reference to the vehicle condition data 234C.

So far, the second example is the same as the first example.

4) The vehicle rental management server 2 transmits the customer ID received from the mobile terminal M1 to the vehicle-mounted terminal 6 having the specified vehicle ID to inquire about whether the customer ID is correct.

5) The vehicle-mounted terminal 6 transmits the customer ID received from the vehicle rental management server 2 to the mobile terminal M1 to inquire about whether the customer ID is correct.

6) The mobile terminal M1 checks whether the customer ID inquired by the vehicle-mounted terminal 6 is identical with a customer ID of the customer carrying the mobile terminal M1, and returns the check result to the vehicle-mounted terminal 6.

7) If they are matched according to the check result, the vehicle rental management server 2 uses the specified vehicle ID as the vehicle ID of the vehicle subject to return reservation.

<Fourth Example of the Process for Specifying Customer and Vehicle>

In the fourth example, a customer is specified based on a customer ID from the mobile terminal M1 and a vehicle is specified with reference to the usage condition database 234 in the same manner as shown in paragraphs 1) to 3) of the first example, but the vehicle rental management server 2 performs a confirmation process by the method different from the first example.

1) The mobile terminal M1 transmits a customer ID to the vehicle rental management server 2.

2) The vehicle rental management server 2 receives the customer ID from the mobile terminal M1.

3) Then, the vehicle rental management server 2 specifies a vehicle ID of a vehicle being rented to the customer having the received customer ID with reference to the vehicle condition data 234C.

So far, the second example is the same as the first example.

4) The vehicle rental management server 2 transmits a request for ID checking to the vehicle-mounted terminal provided on the vehicle having the specified vehicle ID.

5) The vehicle-mounted terminal 6 transmits the request for ID checking received from the vehicle rental management server 2 to the mobile terminal M1.

6) The mobile terminal M1 transmits a customer ID and a confirmation response to the request for ID checking to the vehicle rental management server 2.

7) The vehicle-mounted terminal 6 transmits the confirmation response to the request for ID checking to the vehicle rental management server 2. The confirmation response may include a vehicle ID of the vehicle-mounted terminal 6.

8) If the customer ID of the mobile terminal M1 transmitting the confirmation response is identical with the customer ID of the mobile terminal making a return reservation, the vehicle rental management server 2 uses the specified vehicle ID (or the vehicle ID included in the confirmation response) as a vehicle ID of the vehicle subject to return reservation.

<Fifth Example of Process for Specifying Customer and Vehicle>

In the fifth example, a customer and a vehicle are specified respectively based on the customer ID and the vehicle ID notified from the mobile terminal M1, and the confirmation process is also performed.

1) The mobile terminal M1 acquires in advance a vehicle ID of the vehicle rented by a customer. Examples of the method for acquiring a vehicle ID may include a method of acquiring a vehicle ID by way of communication from the vehicle-mounted terminal 6 or the store terminal M3 and a method of acquiring a vehicle ID by way of manual input. For example, the vehicle ID may be transmitted from the vehicle-mounted terminal 6 to the mobile terminal M1 during a ride. Further, for example, the vehicle ID may be notified to the mobile terminal M1 by setting the store terminal M3 of the rental store during the rental procedure. Furthermore, for example, when the clerk of the rental store rents the vehicle during a rental procedure, the vehicle ID may be set in the mobile terminal M1.

2) The mobile terminal M1 transmits the acquired vehicle ID together with a customer ID to the vehicle rental management server 2.

3) The vehicle rental management server 2 specifies a customer based on the received customer ID and specifies a vehicle based on the received vehicle ID.

In this case, the additional confirmation process is performed to get rid of mistakes.

4) The vehicle rental management server 2 may check whether the vehicle having the received vehicle ID is rented to the customer having the received customer ID with reference to the vehicle operation data 234C1 of the vehicle condition data 234C.

<Sixth Example of Method for Specifying Customer and Vehicle>

In the sixth example, a customer is specified based on a customer ID notified from the mobile terminal M1 and a vehicle is specified based on a vehicle ID notified from the vehicle-mounted terminal 6, and the confirmation process is also performed.

1) The mobile terminal M1 transmits a customer ID to the vehicle rental management server 2.

2) The vehicle rental management server 2 receives the customer ID from the mobile terminal M1 and specifies a customer who rented a vehicle.

3) The mobile terminal M1 notifies the vehicle-mounted terminal 6 of the customer ID. For example, the customer ID may be transmitted from the mobile terminal M1 to the vehicle-mounted terminal 6 during a ride.

4) The vehicle-mounted terminal 6 transmits a customer ID and a vehicle ID to the vehicle rental management server 2. A time for the vehicle-mounted terminal 6 to transmit the customer ID and the vehicle ID to the vehicle rental management server 2 is not particularly limited, but preferably, may be prior to a return reservation or actual return.

5) The vehicle rental management server 2 receives the customer ID and the vehicle ID from the vehicle-mounted terminal 6, and verifies whether the customer ID received from the mobile terminal M1 is identical with the customer ID received from the vehicle-mounted terminal 6. If they are identical with each other, the vehicle rental management server 2 specifies the vehicle ID received from the vehicle-mounted terminal 6 as a vehicle ID of the vehicle subject to return reservation.

6) In this case, the vehicle rental management server 2 may confirm that the vehicle is being rented to the customer with reference to the vehicle condition data 234C to get rid of mistakes.

<Seventh Example of Method for Specifying Customer and Vehicle>

In the seventh example, a customer is specified based on a customer ID notified from the mobile terminal M1 and a vehicle is specified based on a vehicle ID notified from the vehicle-mounted terminal 6, and the confirmation process is performed by the vehicle-mounted terminal 6.

1) The mobile terminal M1 transmits a customer ID to the vehicle rental management server 2.

2) The mobile terminal M1 notifies the vehicle-mounted terminal 6 of the customer ID of a customer renting a vehicle.

3) The vehicle rental management server 2 receives the customer ID from the mobile terminal M1 and specifies a vehicle rented to the customer with reference to the vehicle condition data 234C.

4) By way of communication with the vehicle-mounted terminal 6 installed in the vehicle having a specified vehicle ID, the vehicle rental management server 2 transmits the customer ID received from the mobile terminal M1 to the vehicle-mounted terminal 6 to inquire about whether the customer ID is correct.

5) The vehicle-mounted terminal 6 checks whether the customer ID received from the vehicle rental management server 2 is identical with the customer ID notified from the mobile terminal M1 and transmits the check result to the vehicle rental management server 2.

6) If they are matched according to the check result, the vehicle rental management server 2 uses the specified vehicle ID as a vehicle ID of the vehicle subject to return reservation.

<Eighth Example of Method for Specifying Customer and Vehicle>

In the eighth example, a customer and a vehicle are specified using the current position of the mobile terminal M1 and the current position of the vehicle (vehicle-mounted terminal 6).

1) The vehicle-mounted terminal 6 of the rented vehicle continuously transmits its current position to the vehicle rental management server 2. The vehicle rental management server 2 registers the received current position in the vehicle position data 234C2 relating its vehicle ID. In this case, preferably, a current position of each vehicle can be managed substantially in real time.

2) The mobile terminal M1 of a customer renting a vehicle transmits a customer ID and the current position to the vehicle rental management server 2. The current position is measured by the mobile terminal M1 or the vehicle-mounted terminal 6.

3) The vehicle rental management server 2 receives the customer ID and the current position from the mobile terminal M1.

4) The vehicle rental management server 2 specifies a vehicle that satisfies both the following conditions A) and B) with reference to the vehicle condition data 234C.

A) According to the vehicle position data 234C2, a vehicle is located near the current position of the mobile terminal M1.

B) According to the vehicle operation data 234C1, a vehicle is currently rented to, i.e., rented to but not yet returned from, the customer having the customer ID in the mobile terminal M1.

5) The vehicle rental management server 2 uses the vehicle ID of the specified vehicle as a vehicle ID of the vehicle subject to return reservation.

Further, in this case, as a confirmation process for reducing mistakes, the vehicle rental management server 2 may communicate with the vehicle-mounted terminal 6 with the vehicle ID to acquire the current position from the vehicle-mounted terminal 6 and confirm that the current position is substantially identical with the current position of the mobile terminal M1. Further, the current position is registered in the vehicle position data 234C2 of the vehicle having the vehicle ID.

<Ninth Example of Method for Specifying Customer and Vehicle>

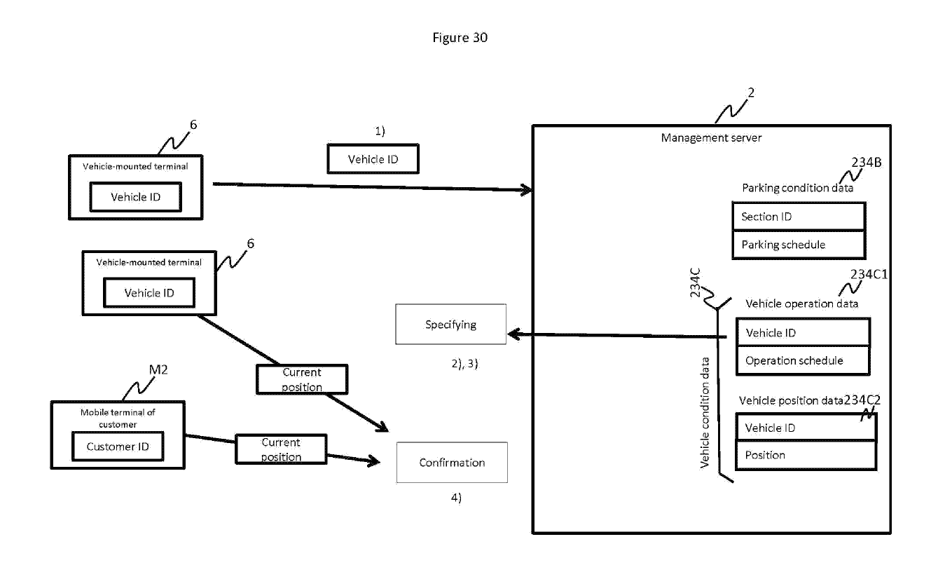

FIG. 30 is a diagram provided to explain a ninth example of the process for specifying a customer and a vehicle. The ninth example is about a basic method for specifying the target customer and the vehicle based on information from the vehicle-mounted terminal 6.

1) Firstly, the vehicle-mounted terminal 6 transmits a vehicle ID to the vehicle rental management server 2.

2) The vehicle rental management server 2 receives the vehicle ID from the vehicle-mounted terminal 6 and specifies a vehicle subject to return reservation or actual return.

3) Then, the vehicle rental management server 2 specifies a customer ID of a customer who currently rents a vehicle having the received vehicle ID, i.e., rents the vehicle but not yet returns the vehicle, with reference to the vehicle operation data 234C1. Further, the vehicle rental management server 2 uses the customer ID as a customer ID of a customer who makes return reservation.

As such, the customer and the vehicle are specified. In this case, in order to reduce mistakes, the same additional confirmation process 4) as described in the first example is allowed to be performed.

4) For example, the vehicle rental management server 2 may receive the current positions of the mobile terminal M1 and the vehicle-mounted terminal 6 having the vehicle ID and check whether the both current positions are actually identical with each other.

<Tenth Example of Method for Specifying Customer and Vehicle>

In the tenth example, a customer and a vehicle are specified by the same processes as shown in paragraphs 1) to 3) of the ninth example, but an additional confirmation process is different from the paragraph 4) of the ninth example.

1) The vehicle-mounted terminal 6 transmits a vehicle ID to the vehicle rental management server 2.

2) The vehicle rental management server 2 receives the vehicle ID from the vehicle-mounted terminal 6.

3) The vehicle rental management server 2 specifies a customer ID of a customer who rents a vehicle having the received vehicle ID, with reference to the vehicle condition data 234C.

So far, the tenth example is the same as the ninth example.

4) The vehicle rental management server 2 refers to the customer master data. In the customer master data, various attributes such as names, mobile phone numbers and nicknames of customers are recorded. The vehicle rental management server 2 acquires a predetermined attribute of the customer having the specified customer ID from the customer master data, transmits the attribute to the vehicle-mounted terminal 6, and requests the vehicle-mounted terminal 6 to check whether the attribute is the correct attribute of the customer. In this case, if there are multiple specified customer IDs, the vehicle rental management server 2 transmits attributes of the multiple customers to the vehicle-mounted terminal 6 so as to display them and requests the customer to select a correct customer.

5) The vehicle-mounted terminal 6 transmits, to the vehicle rental management server 2, information indicating whether the attribute is correct, or whether a customer having a certain attribute is a correct customer according to manual input of the customer.

6) The vehicle rental management server 2 uses the customer ID of the customer considered as having a correct attribute in the vehicle-mounted terminal 6 or the customer ID of the customer selected and notified by the vehicle-mounted terminal 6 as a customer ID of the customer who carries out return reservation or actual return.

<Eleventh Example of Method for Specifying Customer and Vehicle>

In the eleventh example, a customer and a vehicle are specified by the same processes as shown in the paragraphs 1) to 3) of the ninth example, but the additional confirmation process is different from the paragraph 4) of the ninth example.

1) The vehicle-mounted terminal 6 transmits a vehicle ID to the vehicle rental management server 2.

2) The vehicle rental management server 2 receives the vehicle ID from the vehicle-mounted terminal 6.

3) The vehicle rental management server 2 specifies a customer ID of a customer who rents a vehicle having the received vehicle ID, with reference to the vehicle condition data 234C.

So far, the tenth example is the same as the ninth example.

4) The vehicle-mounted terminal 6 transmits a vehicle ID to the mobile terminal M1 at substantially the same time or after the vehicle ID is transmitted to the vehicle rental management server 2 as described in the paragraph 1).

5) The vehicle rental management server 2 communicates with the mobile terminal M1 with the customer ID specified as described in the paragraph 3) and transmits the vehicle ID received from the vehicle-mounted terminal 6 to the mobile terminal M1 to inquire about whether the vehicle ID is correct.

6) The mobile terminal M1 checks whether the vehicle ID received from the vehicle rental management server 2 is identical with the vehicle ID notified from the vehicle-mounted terminal 6. Then, the check result is returned to the vehicle rental management server 2.

7) If they are identical with each other according to the check result from the mobile terminal M1, the vehicle rental management server 2 uses the specified customer ID as a customer ID of the customer who carries out return reservation or actual return.

<Twelfth Example of Method for Specifying Customer and Vehicle>

In the twelfth example, a customer and a vehicle are specified by the same processes as shown in the paragraphs 1) to 3) of the ninth example but an additional confirmation process is different from the paragraph 4) of the ninth example.

1) The vehicle-mounted terminal 6 transmits a vehicle ID to the vehicle rental management server 2.

2) The vehicle rental management server 2 receives a vehicle ID from the vehicle-mounted terminal 6.

3) The vehicle rental management server 2 specifies a customer ID of a customer who rents a vehicle having the received vehicle ID, with reference to the vehicle condition data 234C.

So far, the tenth example is the same as the ninth example.

4) The vehicle rental management server 2 transmits the vehicle ID received from the vehicle-mounted terminal 6 to the mobile terminal M1 with the specified customer ID to inquire about whether the vehicle ID is correct.

5) The mobile terminal M1 transmits the vehicle ID received from the vehicle rental management server 2 to the vehicle-mounted terminal 6 to inquire about whether the vehicle ID is correct.

6) The vehicle-mounted terminal 6 checks whether the vehicle ID received from the mobile terminal M1 is a correct vehicle ID of the vehicle and transmits the check result to the mobile terminal M1.

7) The mobile terminal M1 transmits the check result received from the vehicle-mounted terminal 6 to the vehicle rental management server 2.

8) If they are identical with each other according to the check result, the vehicle rental management server 2 uses the specified vehicle ID as a vehicle ID of the vehicle rented to the customer.

<Thirteenth Example of Method for Specifying Customer and Vehicle>

In the thirteenth example, a customer and a vehicle are specified by the same processes as shown in the paragraphs 1) to 3) of the ninth example but an additional confirmation process is different from the paragraph 4) of the ninth example.

1) The vehicle-mounted terminal 6 transmits a vehicle ID to the vehicle rental management server 2.

2) The vehicle rental management server 2 receives a vehicle ID from the vehicle-mounted terminal 6.

3) The vehicle rental management server 2 specifies a customer ID of a customer who rents a vehicle having the received vehicle ID, with reference to the vehicle condition data 234C.

So far, the tenth example is the same as the ninth example.

4) The vehicle rental management server 2 transmits an ID confirmation request to the mobile terminal M1 with the specified customer ID.

5) The mobile terminal M1 transmits the ID confirmation request received from the vehicle rental management server 2 to the vehicle-mounted terminal 6.

6) The vehicle-mounted terminal 6 transmits a vehicle ID as a confirmation response to the ID confirmation request to the vehicle rental management server 2.

7) The mobile terminal M1 returns the confirmation response to the ID confirmation request to the vehicle rental management server 2. The confirmation response may include a customer ID of the mobile terminal M1.

8) If the vehicle ID of the vehicle-mounted terminal 6 transmitting the confirmation response is identical with a vehicle ID of the vehicle-mounted terminal 6 carrying out return reservation or actual return, the vehicle rental management server 2 uses the specified customer ID (or the customer ID included in the confirmation response) as a customer ID of the customer carrying out return reservation or actual return.

<Fourteenth Example of Method for Specifying Customer and Vehicle>

In the fourteenth example, a customer and a vehicle are specified based on a customer ID and a vehicle ID notified from the vehicle-mounted terminal 6 and the confirmation process is also performed.

1) The vehicle-mounted terminal 6 acquires in advance a customer ID of a customer renting a vehicle. Examples of the methods for acquiring a customer ID may include by way of communication from the mobile terminal M1 or the store terminal M3 and by way of manual input. For example, the customer ID may be transmitted from the mobile terminal M1 to the vehicle-mounted terminal 6 during a ride. Further, for example, the customer ID may be notified to the vehicle-mounted terminal 6 by setting the store terminal M3 of the rental store during a rental procedure. Furthermore, for example, when the clerk of the rental store rents the vehicle during a rental procedure, the customer ID may be set in the vehicle-mounted terminal 6.

2) The vehicle-mounted terminal 6 transmits the acquired customer ID together with a vehicle ID to the vehicle rental management server 2.

3) The vehicle rental management server 2 specifies a customer based on the received customer ID and specifies a vehicle based on the received vehicle ID.

In this case, the additional confirmation process is performed to get rid of mistakes.

4) The vehicle rental management server 2 may check whether the vehicle having the received vehicle ID is rented to the customer having the received customer ID with reference to the vehicle operation data 234C1 of the vehicle condition data 234C.

<Fifteenth Example of Method for Specifying Customer and Vehicle>

In the fifteenth example, a customer is specified based on a customer ID notified from the mobile terminal M1 and a vehicle is specified based on a vehicle ID notified from the vehicle-mounted terminal 6, and the confirmation process is also performed.

1) The vehicle-mounted terminal 6 transmits a vehicle ID to the vehicle rental management server 2.

2) The vehicle rental management server 2 receives the vehicle ID from the vehicle-mounted terminal 6 and specifies a vehicle rented by a customer.

3) The vehicle-mounted terminal 6 notifies the mobile terminal M1 of the vehicle ID. For example, the vehicle ID may be transmitted from the vehicle-mounted terminal 6 to the mobile terminal M1 during a ride.

4) The mobile terminal M1 transmits a customer ID and a vehicle ID to the vehicle rental management server 2. A time for the mobile terminal M1 to transmit the customer ID and the vehicle ID to the vehicle rental management server 2 is not particularly limited, but preferably, may be prior to a return reservation or actual return.

5) The vehicle rental management server 2 receives the customer ID and the vehicle ID from the mobile terminal M1, and verifies whether the vehicle ID received from the vehicle-mounted terminal 6 is identical with the vehicle ID received from the mobile terminal M1. If they are identical with each other, the vehicle rental management server 2 specifies the customer ID received from the mobile terminal M1 as a customer ID of the customer subject to return reservation or actual return.

6) In this case, the vehicle rental management server 2 may confirm that the vehicle is being rented to the customer with reference to the vehicle condition data 234C to get rid of mistakes.

<Sixteenth Example of Method for Specifying Customer and Vehicle>

In the sixteenth example, a customer and a vehicle are specified using a current position of the mobile terminal M1 and a current position of the vehicle (vehicle-mounted terminal 6).

1) The vehicle-mounted terminal 6 of the rented vehicle continuously transmits its current position to the vehicle rental management server 2. The vehicle rental management server 2 registers the received current position in the vehicle position data 234C2 relating its vehicle ID. In this case, preferably, a current position of each vehicle can be managed substantially in real time.

2) The mobile terminal M1 of a customer renting a vehicle transmits a customer ID and the current position to the vehicle rental management server 2. The current position is measured by the mobile terminal M1 or the vehicle-mounted terminal 6.

3) The vehicle rental management server 2 receives the customer ID and the current position from the mobile terminal M1.

4) The vehicle rental management server 2 specifies a vehicle that satisfies both the following conditions A) and B) with reference to the vehicle condition data 234C.

A) According to the vehicle position data 234C2, a vehicle is located near the current position of the mobile terminal M1.

B) According to the vehicle operation data 234C1, a vehicle is currently rented to, i.e., rented to but not yet returned from, the customer having the customer ID in the mobile terminal M1.

5) The vehicle rental management server 2 uses the vehicle ID of the specified vehicle as a vehicle ID of the vehicle subject to return reservation.

Further, in this case, as a confirmation process for reducing mistakes, the vehicle rental management server 2 communicates with the mobile terminal M1 with the customer ID and acquires the current position from the mobile terminal M1 and verifies whether the current position is substantially identical with the current position of the vehicle-mounted terminal 6.

<<Effects>>

According to the present embodiment, the usage condition database 234 (database) of the vehicle rental management server 2 includes usage condition data (for example, a usage schedule of a certain vehicle (to enter or go out at which time) or a schedule of availability) showing information about at which future time each of multiple stores or parking sections (parking sites) can be used for vehicle return. The control unit 22 (control system) ascertains which parking site among the multiple parking sites will be available at which future time, in response to a new return reservation request received from a first terminal among the mobile terminals M1 and/or the vehicle-mounted terminal 6 with reference to the usage condition data 234; specifies a reserved return site and a reserved return time relating to the new return reservation request; and sets a return reservation.

For this reason, the control unit 22 can ascertain which parking site can be used for vehicle return at which time with reference to the usage condition data 234, and when a new return reservation request is received, the control unit 22 can specify a parking site and an available parking time for vehicle return and also receive another new return reservation under such conditions. As a result, it is not necessary for a customer to carry out vehicle rental or reservation thereof and a return reservation at the same time. After a rental reservation or after a vehicle is actually rented, it is possible to separately make a return reservation.

Further, according to the present embodiment, the usage condition database 234 of the storage device 23 includes: rental reservation data showing a reserved rental site and a reserved rental time relating to each of one or more set rental reservations; actual rental data showing an actual rental site and an actual rental time relating to each of one or more actually implemented rental; return reservation data showing a reserved return site and a reserved return time relating to each of one or more set return reservations; and actual return data showing an actual return site and an actual return time relating to each of one or more implemented actual return. The control unit 22 ascertains which parking site among multiple parking sites will be available at which future time based on the rental reservation data, the actual rental data, the return reservation data, and the actual return data.

As such, the usage condition database 234 includes the rental reservation data, the actual rental data, the return reservation data, and the actual return data, the control unit 22 can ascertain vehicle rental conditions over time about whether each parking site can be used at present, at which time and in which parking site each vehicle is scheduled to be rented or returned, or whether each vehicle is actually rented or returned. Thus, it is possible to ascertain about which parking site can be used at which future time, and also possible to readily and accurately set a vehicle return reservation.

Further, according to the present embodiment, if a customer terminal (first terminal) used for return reservation is a mobile terminal, a customer using the customer terminal is specified based on a signal from the customer terminal, a vehicle rented to the specified customer is specified with reference to the usage condition database 234, and a reserved return customer and a reserved return vehicle relating to a new return reservation are specified based on the specified customer and vehicle. If a customer terminal used for return reservation is a vehicle-mounted terminal, a vehicle at which the customer terminal is installed is specified based on a signal from the customer terminal, a customer renting the specified vehicle is specified with reference to the usage condition database 234, and a reserved return customer and a reserved return vehicle relating to a new return reservation are specified based on the specified customer and vehicle. Therefore, it is possible to manage which vehicle is rented to and returned from which customer.

Further, according to the present embodiment, the storage device 23 stores a usage condition database 234 showing information about which vehicle is rented to which customer at which time and a store database 233 (parking site data) showing respective positions of multiple parking sites or information about site terminals. The control unit 22 receives a notice of actual return from a second terminal among the mobile terminal M1, the vehicle-mounted terminal 6, and/or the store terminal M3 (site terminal); ascertains that the notified actual return is carried out based on the notice of actual return and data in the store database 233; specifies an actual return customer who carries out the notified actual return based on the notice of actual return and the usage condition data 234; and specifies an actual return time when the notified actual return is carried out based on the notice of actual return.

Therefore, if a customer rents a vehicle and returns the vehicle in a certain store or parking section available for return without making a return reservation, the control unit can receive a notice of actual return from the mobile terminal M1 of the customer, the vehicle-mounted terminal 6 of the vehicle, or the store terminal M3 and ascertain the actual return based on the notice and also can recognize an actual return customer and an actual return time in real time substantially. In other words, after renting the vehicle, the customer can return the vehicle in a certain store or parking section available for return at a certain time without making a return reservation.

Furthermore, according to the present embodiment, the notice of actual return includes at least one of the following two kinds of information.

First information: Information indicating that any one of the site terminals and any one of the mobile terminals, or any one of the site terminals and any one of the vehicle-mounted terminals come close to each other at or immediately before a time of the notice of actual return (for example, a time set to implement an actual return procedure after a vehicle is parked in a parking site, such as within 3 minutes) (for example, a pair of IDs of both terminals obtained by transferring a terminal ID of one side to the other side by way of near-field communication between the both terminals).

Second information: Information indicating a current position of any one of the mobile terminals or any one of the vehicle-mounted terminals at or immediately before a time of the notice of actual return (for example, a current position measured by a GPS device of the terminal at that time point).

Further, the control unit 22 ascertains that the actual return is implemented based on the first information included in the notice of actual return and information from the store terminals M3 in multiple parking sites shown in the parking site data, or the second information included in the notice of actual return and position information of multiple parking sites shown in the parking site data.

Therefore, it is possible to accurately ascertain implementation of the actual return.

Although the embodiments have been described specifically, the present invention is not limited to the above disclosure and can be modified and changed in various ways without departing from the spirit and scope of the present invention.

For example, in the present embodiment, if the vehicle rental management server 2 acquires rental reservation request information from the mobile terminal M2, the vehicle rental management server 2 may transmit a store ID of a store having a vacant site as a store ID of an available store for return and a store ID of a store, which is a desired rental site in the rental reservation request information from the mobile terminal M2, as a store ID of a store recommendable for return reservation to the mobile terminal M1 that has been transmitting a return reservation request. However, the vehicle rental management server 2 may select a store ID of a store recommendable for return reservation with respect to the mobile terminal M1 regardless of the rental reservation request information from the mobile terminal M2. That is, in response to a new return reservation request from the mobile terminal M1, the vehicle rental management server 2 may transmit information indicating which parking site and/or which future time available for vehicle return relating to the return reservation and also select a parking site and/or a future time recommendable for vehicle return under a certain condition and transmit information about the selected parking site and/or future time to the mobile terminal M1.

### REFERENCE SIGNS LIST

M1, M2 . . . Mobile terminal, M3 . . . Store terminal, S . . . Store, U1 . . . Customer (Current customer), U2 . . . Customer (Next customer), U3 . . . Clerk, 2 . . . Vehicle rental management server, 3 . . . Communication network, 4 . . . Wireless base station, 5, Repeater, 6 . . . Vehicle-mounted terminal, 7 . . . Satellite, 8 . . . Reader, 11 . . . Wireless interface, 11a . . . Short distance wireless communication unit, 12 . . . Input interface, 13 . . . Output interface, 13a . . . Display unit, 14 . . . Position information acquisition unit 15 . . . Memory, 16 . . . Usage information transmitting unit, 17 . . . Application execution unit, 17a . . . UI control unit, 17b . . . Reservation setting unit 17c . . . Arrival information notifying unit 21 . . . Communication interface, 22 . . . Control unit, 23 . . . Storage device, 24 . . . Timing unit 31 . . . Communication interface, 31a . . . Short distance wireless communication unit 32 . . . Input interface, 33 . . . Output interface, 33a . . . Display unit, 34 . . . Camera, 35 . . . Memory, 36 . . . Usage information transmitting unit 37 . . . Application execution unit, 37a . . . UI control unit, 61 . . . Wireless interface, 62 . . . Input interface, 63 . . . Output interface, 63a . . . Display unit, 64 . . . Control unit, 64a . . . Engine control unit, 64b . . . Door locking control unit, 64c . . . Navigation control unit, 65 . . . Position detection unit, 65a . . . Gyro sensor, 65b . . . GPS receiver, 65c . . . Acceleration sensor, 66 . . . Memory, 67 . . . Short distance wireless communication unit 81 . . . Identification information acquisition unit, 82 . . . Output interface, 171 . . . Mobile terminal, 172 . . . Personal computer, 173 . . . Server device, 174 . . . Dedicated device, 181 . . . Optical disc, 181˜85. Storage medium, 182 . . . Cassette tape, 183 . . . Flexible disc, 184 . . . Memory card, 185 . . . USB memory, 186 . . . IC chip, 221 . . . Authentication unit, 222 . . . Manipulation signal acquisition unit, 223 . . . Rental management unit, 223a . . . Reservation receiving unit, 223b . . . Return receiving unit, 224 . . . Member registration unit, 225 . . . Information providing unit, 226 . . . Store-side information acquisition unit, 227 . . . Payment processing unit, 228 . . . Comparison unit, 229 . . . Point management unit, 231 . . . Map information accumulation unit, 232 . . . Customer database, 233 . . . Store database, 233A . . . Store master, 233B . . . Parking lot master, 234 . . . Usage condition database, 234A . . . Contract management data, 234B . . . Parking condition data, 234C . . . Vehicle condition data, 234C1 . . . Vehicle operation data, 234C2 . . . Vehicle position data, 235 . . . Vehicle database, 235A . . . Vehicle master

1. A vehicle rental management system that can communicate with multiple mobile terminals respectively carried by multiple customers and/or multiple vehicle-mounted terminals respectively provided on multiple vehicles and manages a vehicle rental business of renting the vehicles to the customers, the vehicle rental management system comprising:
a control system that manages reservation and implementation of rental and return of the vehicles; and
a database accessed by the control system,
wherein the database includes usage condition data showing information about at which future time each of multiple parking sites prepared as rental sites and return sites for the vehicles can be used for vehicle return, and the control system specifies a reserved return site and a reserved return time relating to the new return reservation request by ascertaining which parking site among the multiple parking sites at which future time can be used, in response to a new return reservation request received from a first terminal among the mobile terminals and/or the vehicle-mounted terminals with reference to the usage condition data, and sets a return reservation determining the specified reserved return site and reserved return time.

2. The vehicle rental management system according to claim 1,
wherein the control system performs any one of processes of (1) and (2) to specify the reserved return site and the reserved return time relating to the return reservation, comprising;
(1) receiving a desired return time from the first terminal; ascertaining one or more parking sites available at the desired return time with reference to the usage condition data; specifying the reserved return time based on the desired return time; and specifying the reserved return site based on the ascertained one or more parking sites; and
(2) receiving a desired return area from the first terminal; ascertaining one or more future times at which the desired return site can be used with reference to the usage condition data; specifying the reserved return site based on the desired return site; and specifying the reserved return time based on the one or more ascertained future times.

3. The vehicle rental management system according to claim 1,
wherein the usage condition data includes:
rental reservation data showing a reserved rental site and a reserved rental time relating to each of one or more set rental reservations;
actual rental data showing an actual rental site and an actual rental time relating to each of one or more implemented actual rental;
return reservation data showing a reserved return site and a reserved return time relating to each of one or more set return reservations; and
actual return data showing an actual return site and an actual return time relating to each of one or more implemented actual return, and
the control system ascertains which parking site among multiple parking sites at which future time can be used based on the rental reservation data, the actual rental data, the return reservation data, and the actual return data.

4. The vehicle rental management system according to claim 3,
wherein the rental reservation data further shows a reserving rental customer and a reserved rental vehicle relating to each of the rental reservations;
the actual rental data further shows an actual rental customer and an actual rental vehicle relating to each of the actual rentals;
the return reservation data further shows a return reservation customer and a return reservation vehicle relating to the return reservation; and
the actual return data further shows an actual return customer and an actual return vehicle relating to the actual return, and
the control system performs any one of processes of (3) and (4) in response to the new return reservation request from the first terminal, comprising:
(3) in the case where the first terminal is a mobile terminal, specifying a customer using the first terminal based on a signal from the first terminal; specifying a vehicle rented to the specified customer with reference to the usage condition data; specifying the return reservation customer and the return reservation vehicle relating to the new return reservation based on the specified customer and vehicle; and registering the new return reservation data showing the return reservation customer and the return reservation vehicle relating to the new return reservation into the usage condition data; and
(4) in the case where the first terminal is a vehicle-mounted terminal, specifying a vehicle provided with the first terminal based on a signal from the first terminal; specifying a customer renting the specified vehicle with reference to the usage condition data; specifying the return reservation customer and the return reservation vehicle relating to the new return reservation based on the specified customer and vehicle; and registering the new return reservation data showing the return reservation customer and the return reservation vehicle relating to the new return reservation into the database.

5. The vehicle rental management system according to claim 1,
wherein in response to the new return reservation request, the control system transmits information indicating which parking site and/or which future time can be used for vehicle return relating to the new return reservation and information relating to a parking site and/or a future time recommendable for the vehicle return to the first terminal, and specifies the reserved return site and the reserved return time relating to the new return reservation based on the signal received from the first terminal.

6. The vehicle rental management system according to claim 5,
wherein the usage condition data further shows information about which parking site at which future time can be used for vehicle rental, and
the control system receives a rental reservation request from a new customer designating a parking site and a future time which cannot be used for vehicle rental according to the usage condition data, and suggests the parking site designated by the new customer as the rental reservation request so as to be selected as a candidate site for the reserved return site recommendable for vehicle return of the return reservation in response to a return reservation request from a customer renting the vehicle.

7. A vehicle rental management system that can communicate with multiple mobile terminals respectively carried by multiple customers, multiple vehicle-mounted terminals respectively provided on multiple vehicles, and/or site terminals respectively provided on multiple parking sites prepared as rental sites and return sites for the vehicles, and manages a vehicle rental business of renting the vehicles to the customers, the vehicle rental management system comprising:
a control system that manages rental and return of the vehicles; and
a database accessed by the control system,
wherein the database includes usage condition data showing information about which vehicle is rented to which customer at which time and parking site data showing respective positions of the multiple parking sites and information about the site terminals, and the control system receives a notice of actual return from a second terminal among the mobile terminals, the vehicle-mounted terminals, and/or the site terminals, confirms a fact of implementation of the notified actual return based on the notice of actual return and the parking site data, specifies an actual return customer implementing the notified actual return based on the notice of actual return and the usage condition data, and specifies an actual return time at which the notified actual return is implemented based on the notice of actual return.

8. The vehicle rental management system according to claim 7,
wherein the notice of actual return includes at least one of information of (5) and (6):
(5) first information indicating a fact that any one of the site terminals and any one of the mobile terminals, or any one of the site terminals and any one of the vehicle-mounted terminals came close to each other at or immediately before a time of the notice of actual return; and
(6) second information indicating a current position of any one of the mobile terminals or any one of the vehicle-mounted terminal at or immediately before a time of the notice of actual return, and
the control system confirms the fact of the implementation of the actual return based on the first information included in the notice of actual return and information of the site terminals of the multiple parking sites shown in the parking site data, or the second information included in the notice of actual return and information of positions of the multiple parking sites shown in the parking site data.

9. The vehicle rental management system according to claim 7 or 8,
wherein the control system performs any one of the following processes of (7), (8), and (9) in response to the new notice of actual return from the second terminal, and specifies an actual return customer implementing the new actual return based on the specified customer, comprising:
(7) in the case where the second terminal is a mobile terminal, specifying a customer using the second terminal based on a signal from the second terminal;
(8) in the case where the second terminal is a vehicle-mounted terminal, specifying a vehicle provided with the second terminal based on a signal from the second terminal; and specifying a customer renting the specified vehicle based on the usage condition data; and
(9) in the case where the second terminal is a site terminal, specifying a vehicle provided with a vehicle-mounted terminal coming close to the second terminal, or a customer using a mobile terminal coming close to the second terminal based on the first information included in the notice of actual return from the second terminal; and in the case where the vehicle is specified based on the first information, specifying a customer renting the specified vehicle based on the usage condition data.

10. A vehicle rental management system that can communicate with multiple vehicle terminals respectively provided on multiple vehicles and manages a vehicle rental business of renting the vehicles to customers, the vehicle rental management system comprising:
a control system that manages reservation and implementation of rental and return of the vehicles; and
a database accessed by the control system,
wherein the database includes parking site data showing information about multiple parking sites prepared as rental sites and return sites for the vehicles, and the control system ascertains a reserved return site and a reserved return time relating to a return reservation based on a parking site set as a destination and an estimated arrival time at the parking site determined based on a current position measured by the vehicle-mounted terminal, and sets a next rental reservation for the vehicle based on the return reservation.

11. A non-transitory computer-readable medium containing a vehicle rental management program for operating a computer as a vehicle rental management system that can communicate with multiple mobile terminals respectively carried by multiple customers and/or multiple vehicle-mounted terminals respectively provided on multiple vehicles and manages a vehicle rental business of renting the vehicles to the customers, the vehicle rental management program comprising the instructions for:
maintaining, in a database, usage condition data showing information indicating which future time can be used for vehicle return in each of multiple parking sites prepared as rental sites and return sites for the vehicles,
specifying a reserved return site and a reserved return time relating to the new return reservation request by ascertaining which parking site among the multiple parking sites at which future time can be used, in response to a new return reservation request received from a first terminal among the mobile terminals and/or the vehicle-mounted terminals with reference to the usage condition data, and
setting a return reservation determining the specified reserved return site and reserved return time.

12. A non-transitory computer-readable medium containing a vehicle rental management program for operating a computer as a vehicle rental management system that can communicate with multiple mobile terminals respectively carried by multiple customers, multiple vehicle-mounted terminals respectively provided on multiple vehicles, and/or site terminals respectively provided on multiple parking sites prepared as rental sites and return sites for the vehicles, and manages a vehicle rental business of renting the vehicles to the customers, the vehicle rental management program comprising the instructions for:
maintaining, in a database, usage condition data showing information indicating which vehicle is rented to which customer at which time and parking site data showing information indicating respective positions of the multiple parking sites or information about the site terminals,
receiving a notice of actual return from a second terminal among the mobile terminals, the vehicle-mounted terminals, and/or the site terminals,
confirming a fact of implementation of the notified actual return based on the notice of actual return and the parking site data,
specifying an actual return customer implementing the notified actual return based on the notice of actual return and the usage condition data, and
specifying an actual return time when the notified actual return is implemented based on the notice of actual return.

13. A non-transitory computer-readable medium containing a vehicle rental management program for operating a computer as a vehicle rental management system that can communicate with multiple vehicle terminals respectively provided on multiple vehicles and manages a vehicle rental business of renting the vehicles to customers, the vehicle rental management program comprising the instructions for:
maintaining, in a database, parking site data showing information about multiple parking sites prepared as rental sites and return sites for the vehicles,
ascertaining a reserved return site and a reserved return time relating to a return reservation based on a parking site set as a destination and an estimated arrival time at the parking site determined based on a current position measured by the vehicle-mounted terminal, and
setting a next rental reservation for the vehicle based on the return reservation.

14. A vehicle rental customer terminal that can communicate a vehicle rental management server that manages a vehicle rental business of renting a vehicle to a customer, and is used by the customer, the vehicle rental customer terminal comprising:
a communication interface that transmits/receives a signal to/from the vehicle rental management server; and
a control unit that communicates with the vehicle rental management server using the communication interface,
wherein when the customer makes a return reservation for a vehicle being rented, the control unit transmits customer identification information of the customer or vehicle identification information of the vehicle and a desired return time or a desired return area input by the customer to the vehicle rental management server, receives parking sites or future times that can be used for return of the vehicle relating to the return reservation from the vehicle rental management server, suggests the received parking sites or future times to the customer so as to recommend the customer to select, and notifies the vehicle rental management server of the selected parking site or future time.

15. The vehicle rental customer terminal according to claim 14,
wherein the vehicle rental customer terminal is a mobile terminal carried by the customer, and
the control unit transmits the customer identification information of the customer to the vehicle rental management server, receives the vehicle identification information considered to be that of the vehicle rented by the customer from the vehicle rental management server, recommends the customer to confirm the vehicle identification information, and transmits the confirmation result to the vehicle rental management server.

16. The vehicle rental customer terminal according to claim 14,
wherein the vehicle rental customer terminal is a vehicle-mounted terminal provided on the vehicle, and
the control unit transmits the vehicle identification information of the vehicle to the vehicle rental management server, receives the customer identification information considered to be that of the customer renting the vehicle from the vehicle rental management server, recommends the customer to confirm the customer identification information, and transmits the confirmation result to the vehicle rental management server.

17. The vehicle rental customer terminal according to claim 14,
wherein the vehicle rental customer terminal is a mobile terminal carried by the customer, and
the control unit further transmits the customer identification information from the vehicle-mounted terminal to the vehicle rental management server by notifying a vehicle-mounted terminal of the vehicle rented by the customer of the customer identification information of the customer.

18. The vehicle rental customer terminal according to claim 14,
wherein the vehicle rental customer terminal is a vehicle-mounted terminal provided on the vehicle, and
the control unit further transmits the vehicle identification information from the mobile terminal to the vehicle rental management server by notifying a mobile terminal of the customer renting the vehicle of the vehicle identification information of the vehicle.

19. A non-transitory computer-readable medium containing a vehicle rental customer terminal program for operating an information processing terminal comprising a communication interface configured to transmit/receive a signal as a vehicle rental customer terminal that can communicate with a vehicle rental management server that manages a vehicle rental business of renting a vehicle to a customer and is used by the customer, the vehicle rental customer terminal program comprising the instructions for:
at the time when the customer makes a return reservation for a vehicle being rented, transmitting customer identification information of the customer and/or vehicle identification information of the vehicle and a desired return time or a desired return area input by the customer to the vehicle rental management server using the communication interface,
receiving a parking site or future time that can be used for vehicle return of the return reservation from the vehicle rental management server using the communication interface,
suggesting the received parking site or future time to the customer so as to recommend the customer to select, and
notifying the vehicle rental management server of the selected parking site or future time using the communication interface.
